(19) United States
(12) Patent Application Publication
(10) Pub. No.: US 2021/0335333 A1
(43) Pub. Date: Oct. 28, 2021

(54) COMPUTING ORDERS OF MODELED EXPECTATION ACROSS FEATURES OF MEDIA

(71) Applicant: Secret Chord Laboratories, Inc., Norfolk, VA (US)

(72) Inventors: Scott Miles, Norfolk, VA (US); David Rosen, Philadelphia, PA (US); Shaun Barry, Newtown Square, PA (US)

(73) Assignee: Secret Chord Laboratories, Inc., Norfolk, VA (US)

(21) Appl. No.: 17/369,664

(22) Filed: Jul. 7, 2021

Related U.S. Application Data
(63) Continuation of application No. 17/025,819, filed on Sep. 18, 2020.
(60) Provisional application No. 62/904,748, filed on Sep. 24, 2019.

(51) Int. Cl. G10H 1/00; G06F 16/635; G06F 16/65; G06F 16/683; G06Q 30/02

(52) U.S. Cl. CPC G10H 1/0008; G06F 16/635; G06F 16/65; G06F 16/683; G10H 2210/066; G10H 2210/105; G10H 2210/021; G10H 2210/051; G10H 2210/071; G06Q 30/0205

(57) ABSTRACT

A method implemented by a determination engine is provided. The determination engine receives a media dataset comprising target piece music information, target piece audience information, corpus music information, corpus audience information, and corpus preference data. The determination engine determines a subset of the corpus music and preference information and determines at least one surprise factor of the subset of the corpus music and preference information across features at one of a plurality of orders. The determination engine learns a model that estimates a likelihood that time-varying surprise trends across the features achieves a preference level. The determination engine determines at least one surprise factor of the target piece music information across the features at the one of the plurality of orders and predicts, using the model, preference information using the time-varying surprise trends for the target piece music information across the features.

### CROSS REFERENCE TO RELATED APPLICATIONS

This application which claims the benefit of U.S. Provisional Application 62/904,748, filed Sep. 24, 2019, the contents of which are hereby incorporated by reference herein.

### FIELD OF INVENTION

The present invention is directed to artificial intelligence and/or machine learning methods and systems. More particularly, the present invention relates to a machine learning algorithm that computes orders of modeled expectation across features of media.

### BACKGROUND

In general, conventional music selection methods and systems attempt to account for music preferences of a listener when providing music selections and recommendations to that listener. Music preferences can include a partiality by the listener of one or more sound types, piece of music types, genres, and/or styles. Yet, conventional music selection methods and systems fail to account for other factors, such as harmonic surprise and expectation violations, when providing music selections and recommendations. Harmonic surprise can include a point in which music deviates from an expectation of the listener. Expectation violation can include how the listener responds to unanticipated breaches of music norms. What is needed is a reliable method and system that can provide improved information to a user based on factors beyond mere music preference.

### BRIEF DESCRIPTION OF THE DRAWINGS

A more detailed understanding can be had from the following description, given by way of example in conjunction with the accompanying drawings wherein:

FIG. 1 illustrates a system for computing orders of modeled expectation across features of music within a corpus of music according to one or more embodiments;

FIG. 2 illustrates a process flow of combining aspects of the system of FIG. 1 according to one or more embodiments;

FIG. 3 illustrates an alternative flow of the process flow of FIG. 2 according to one or more embodiments;

FIG. 4 illustrates a system for computing orders of modeled expectation across features of music within a corpus of music according to one or more embodiments;

FIG. 5 illustrates a method according to one or more embodiments;

FIG. 6 illustrates a method according to one or more embodiments;

FIG. 7 illustrates a method for determining repetition within pieces of music in a corpus of music according to one or more embodiments;

FIG. 8 illustrates a method for executing a preference analysis according to one or more embodiments;

FIG. 9 illustrates a method for executing a quartile analysis according to one or more embodiments;

FIG. 10 illustrates a method for executing a within-artist analysis according to one or more embodiments;

FIG. 11 illustrates a method for determining a key within pieces of music in a corpus of music according to one or more embodiments;

FIG. 12 illustrates a method for determining duration within pieces of music in a corpus of music according to one or more embodiments;

FIG. 13 illustrates a method for determining tempo within pieces of music in a corpus of music according to one or more embodiments;

FIG. 14 illustrates a method for determining harmony within pieces of music in a corpus of music according to one or more embodiments;

FIG. 15 illustrates a method for determining melody within pieces of music in a corpus of music according to one or more embodiments;

FIG. 16 illustrates a method for determining rhythm within pieces of music in a corpus of music according to one or more embodiments;

FIG. 17 illustrates a method for determining timbre within pieces of music in a corpus of music according to one or more embodiments;

FIG. 18 illustrates a method for determining texture within pieces of music in a corpus of music according to one or more embodiments;

FIG. 19 illustrates a method for determining dynamics within the pieces of music in a corpus of music according to one or more embodiments;

FIG. 20 is a block diagram of an example device according to one or more embodiments; and

FIG. 21 illustrates a data flow within the system of FIG. 4 according to one or more embodiments.

### DETAILED DESCRIPTION

Disclosed herein is an artificial intelligence and/or machine learning method and system. More particularly, the present invention relates to a machine learning algorithm (e.g., a determination engine) that computes orders of modeled expectation across features of media. The determination engine is processor executable code or software that is necessarily rooted in process operation by, and in processing hardware of, digital media equipment to evaluate media based on a number of features within the media.

According to an embodiment, the determination engine (e.g., which is executed by one or more processors) receives a media dataset comprising target piece music information, target piece audience information, corpus music information, corpus audience information, and corpus preference data. The determination engine determines a subset of the corpus music and preference information utilizing a similarity of the target piece audience information and the corpus audience information and at least one surprise factor of the subset of the corpus music and preference information across a plurality of features at one of a plurality of orders. The determination engine learns, within the subset of the corpus music and preference information, a model that estimates a likelihood that one or more time-varying surprise trends across the plurality of features achieves a preference level. The determination engine determines at least one surprise factor of the target piece music information across the plurality of features at the one of the plurality of orders and predicts, using the model, preference information using the one or more time-varying surprise trends for the target piece music information across the plurality of features. The technical effects and benefits of the determination engine include a multi-step manipulation of the media dataset that produces improved media selections, preference information, predictions, and recommendations to a user based on factors beyond mere media preference.

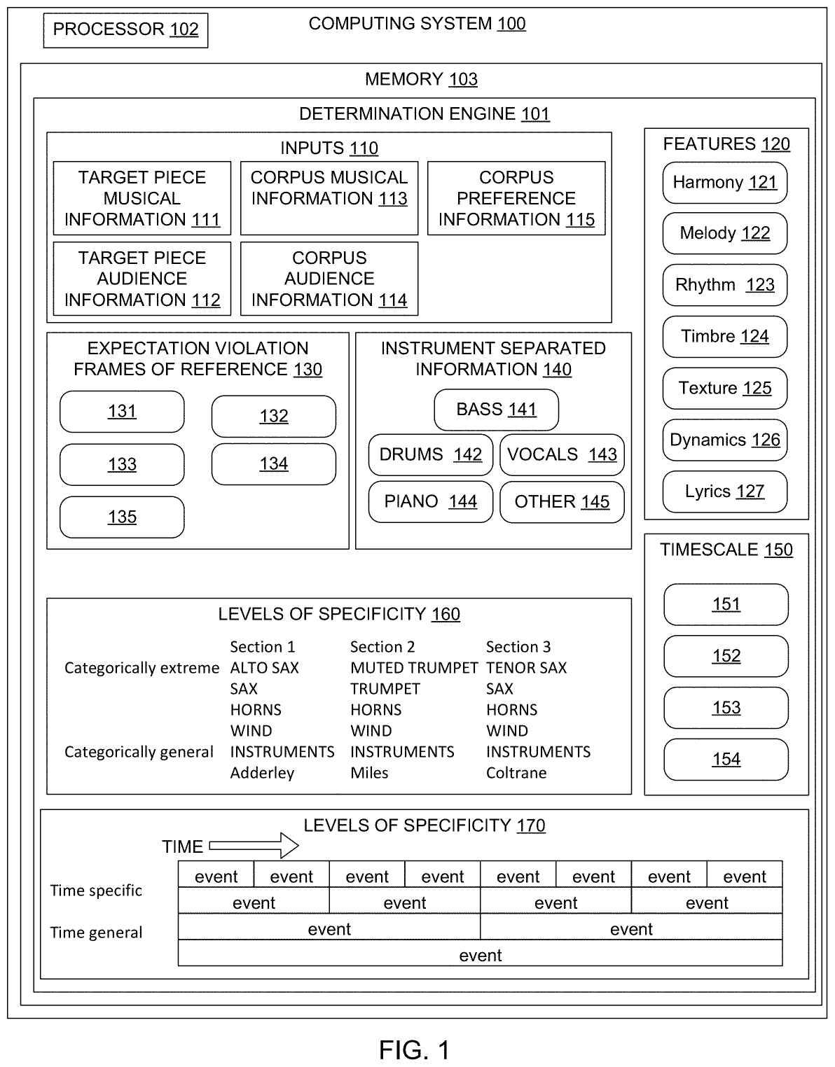

FIG. 1 illustrates a system (e.g., a computing system 100) for computing orders of modeled expectation across features of music within a corpus of music. The computing system 100 may include any computing device that employs the machine learning algorithm (represented as a determination engine 101). Note that the computing system 100 is representative of one or more examples of digital media equipment that can be used to generate, record, edit, play, and store media. Media includes any sensory outlet or tool used to store and deliver information or data. Examples of media include, but are not limited to, video (e.g., movies), audio (e.g., pieces of music, podcasts, etc.), video games, print media (e.g., news articles or publications), photography (e.g., digitally recorded images), art (e.g., digitally recorded paintings), and advertisements.

According to an embodiment, the computing system 100 includes the one or more processors 102 (any computing hardware) and the memory 103 (any non-transitory tangible media). The one or more processors 102 execute computer instructions with respect the determination engine 101. The memory 103 stores these instructions for execution by the one or more processors 102. For instance, the computing system 100 may be programmed by the determination engine 101 (in software) to carry out the functions of receiving a media dataset including target piece music information, target piece audience information, corpus music information, corpus audience information, and corpus preference data; determining a subset of the corpus music and preference information and determines at least one surprise factor of the subset of the corpus music and preference information across features at one of a plurality of orders; learning a model that estimates a likelihood that time-varying surprise trends across the features achieves a preference level; determining at least one surprise factor of the target piece music information across the features at the one of the plurality of orders; and predicting, using the model, preference information using the time-varying surprise trends for the target piece music information across the features.

A media dataset, in general, is a digital collection of instances of media, associated metadata, and other information. For example, a media dataset can include a selection of pieces of music, corresponding lyrics, corresponding artist and record label information, metadata describing genre and instruments, metadata describing piece of music length. For example, a media dataset can include a selection of movies and movie scores, corresponding lyrics and scripts, corresponding producers and record studio information, metadata describing genre and actors, metadata describing runtime and viewing rating. In an embodiment, the media dataset can include a target piece, such as a video, an audio recording, a video game, a print media, a photograph, an art instance, an advertisement, or a portion thereof.

According to one or more exemplary embodiments, while the determination engine 101 is shown within the memory 103 of the computing system 100, the determination engine 101 may be external to the computing system 100 and may be located, for example, in an external device, in a mobile device, in a cloud-based device, or may be a standalone processor. In this regard, the determination engine 101 may be transferable/downloaded in electronic form, over a network.

As shown in FIG. 1, the determination engine 101 includes inputs 110 including target piece musical information 111, target piece audience information 112, corpus musical information 113, corpus audience information 114, and corpus preference information 115. The inputs 110 can be in the form of an audio file, musical instrument digital interface (MIDI) file, a transcription, and/or other representation of the corpus. According to an embodiment, the target piece musical information 111 represents information that is measured against computed ideal ranges and attentions of both raw information and expectation violation calculations established from a preference model as outlined herein. The inputs also include a corpus (e.g., the corpus musical information 113, the corpus audience information 114, and the corpus preference information 115), which is musically relevant information and preference information about pieces of music. Different pieces from the corpus are included in different levels of the analysis according to data from the target piece audience information 112 that matches or aligns with the corpus audience information 114. For example, given the target piece audience information 112, only pieces from the corpus with matching this audience information will be included in the audience-dependent level of the analysis.

The determination engine 101 includes features 120 including harmony 121, melody 122, rhythm 123, timbre 124, texture 125, dynamics 126, and lyrics 127. The determination engine 101 includes expectation violation frames of reference 130 including corpus-wide frames of reference 131, time period-dependent frame of reference 132, audience-dependent frames of reference 133, artist-dependent frames of reference 134, and frames of reference within a piece of music 135. The determination engine 101 includes instrument-separated information 140. In an example, the instrument-separated information 140 can include different channels of instruments, such as bass 141, drums 142, vocals 143, piano 144, and other instrument information 145. The determination engine 101 includes timescales 150 over which the computer system 100 operates. By way of example, the timescales 150 can include absolute 151, relative 152, musically relevant times 153, and sections 154. The determination engine 101 can provide levels of specificity 160 of a category (note that the timbre 124 is the example shown in FIG. 1). Note that each specificity may be described from a general sense to an extreme specificity sense within the category (as illustrated in the various specificities provided within the sections 1, 2, and 4 from very specific (at the top) to becoming more general as descending in the column. The determination engine 101 can provide levels of specificity 170 of time. This includes specific times and timescales to the general times and timescales, as illustrated.

According to an embodiment, the corpus musical information 113 is identified, calculated, and recorded as raw measures of events associated with the features 120, at the level of instrument separated information 140 (and as a whole). In addition to being identified, calculated, and recorded as measures of events associated with the features, this information is also used to determine measures of expectation violation at the level of expectation violation frames of reference 130. In the calculation of measures of expectation violation, attentions are adjusted to contribute to the formation of a predictive model that establishes ideal ranges and attentions for features 120, at expectation violation frames of reference 130, at types of instrument separated information 140 (and the piece as a whole), at levels of specificity of category 160 and at levels of specificity of time 170. The attentions uses levels of specificity of category 160 and at levels of specificity of time 170 to calculate raw measures of events and to calculate expectation violation, which are adjusted through a back-propagating, recursive process to optimize a model that best fits the relationship among weighted raw measures of events, weighted measures of expectation violation, and weighted considerations of corpus preference information 115.

In view of the framework of the determination engine 101 shown in FIG. 1, a discussion of how the determination engine 101 provides improved selections, preference information, predictions, and recommendations to a user based on factors, such as harmonic surprise and expectation violations is discussed. Note that, for ease of explanation, music and target music pieces are utilized to describe the operation of the determination engine 101. Yet, the determination engine 101 is not limited to music and may be application to one or more types of media as described herein.

In general, musical pieces may preferentially activate reward centers in a brain of a listener. Both unexpected events in music (“absolute surprise”) and the juxtaposition of unexpected events and subsequent expected events (“contrastive surprise”) lead to an overall rewarding response. Therefore, comparing the absolute surprise and the contrastive surprise of past pieces of music in a corpus to their popularity (e.g., a corresponding chart position) reveals a correlation between surprise and popularity. For example, the determination engine 101 seeks to identify and utilize relationships between music preference and at least one surprise factor (e.g., harmonic surprise, melodic surprise, rhythmic surprise, timbre surprise, texture surprise, dynamic surprise, lyrical surprise, etc.), as well as how music preference is affected by expectation violation associated with other features within music. Additionally, the determination engine 101 can leverage an incorporation of prior conditions on the calculations of modeled expectation to improve the reliability of predictions of music preference, as well as media selections, preference information, predictions, and recommendations.

In turn, a design of the determination engine 101 is rooted in computing for at least one of plurality of orders (e.g., zeroth-order, first-order, second-order, etc. of a modeled expectation) across features (e.g., harmony, melody, rhythm, timbre, texture, dynamics, lyrics, etc.), given input associated with a piece of music (e.g., new release, piece of music in progress of composition, or existing piece of music), through an audio file, MIDI file, or transcription. Note that number of orders of the plurality of orders can be an integer greater than one.

The design of the determination engine 101 is further rooted in returning to the user output information indicating preference information, such as predicted preference of that piece of music according to the expectations of a given intended audience (e.g., based on a geographic region). In accordance with one or more embodiments, the determination engine 101 computes/determines several orders of modeled expectation across several features for any individual media or media dataset. Geographic region can include, but is not limited to, a demarcated area of earth, such as a continent, a country, a state, a territory, a city, a metropolitan area, a region, a collection of regions, county, a town, a village, etc.

Note that comparing (by the determination engine 101) relationship between surprise and popularity over time reveals that the preferred level of surprise increases over time in an inflationary manner. Therefore, by determining (by the determination engine 101) correlations between surprise and popularity over time, the determination engine 101 can identify a minimum preferred surprise for a particular moment in time. The minimum preferred surprise is a dynamic threshold established within a context of other factors within a corpus (e.g., inputs 110). For instance, harmonic surprise (e.g., a point in which music deviates from an expectation of the listener) may include absolute harmonic surprise and/or contrastive harmonic surprise. Comparing a relationship between harmonic surprise and popularity over time reveals that the preferred level of harmonic surprise increases over time in an inflationary manner. Therefore, by determining correlations between harmonic surprise and popularity over time, the determination engine 101 can identify a minimum preferred harmonic surprise for a particular moment in time. Additionally, in some cases, a rise of surprise among the most popular (top-quartile) pieces of music may level off around six bits, suggesting a ceiling effect. Therefore, based on the correlations over time, the determination engine 101 can identify a maximum preferred harmonic surprise for a particular moment in time. The maximum preferred surprise is a dynamic threshold established within a context of other factors within a corpus (e.g., inputs 110). Additionally, as described in more detail herein, new chord progressions are generated (e.g., by the determination engine 101) to form verses and choruses, using dependences of “previous bar” and “bar four bars previous” from a corpus of chord progressions. Potential chord progressions were selected (e.g., by the determination engine 101) for proximity to pre-determined per-section average surprise levels. Those chord progressions were then used to generate and record (e.g., by the determination engine 101) a musical representation of verses and choruses. Accordingly, the determination engine 101 may be used to generate new musical representations, based on the corpus and the minimum (and, optionally, maximum) preferred harmonic surprise. The determination engine 101, in operation with respect to computing higher-order measures of expectation of harmony (as well as in expectation of other features, and their relationship to music preference), has shown that an incorporation of information from all these measures together lead to a far more robust predictive model of how pieces of music will ultimately be preferred.

Note that, as discussed herein, the relationship between music preference and surprise is leveraged (due to its significance) by the determination engine 101. Further, because music preference is also affected by expectation violation associated with other features within pieces of music, the determination engine 101 can leverage this affect as well. Furthermore, the determination engine 101 can incorporate prior conditions in calculations of modeled expectation violation to improve a reliability of predictions of music preference. Such prior conditions might include, but are not limited to, events that occur earlier in a piece of music, events associated with other features being measured, etc. Moreover, in view of dynamic interdependent relationships that exist among events associated with these features themselves, among modeled expectations associated with such events, and among resulting effects of both events and expectations on music preference, the determination engine 101 reliably predicts music preference through iterative, back-propagating calculations of attentions applied to descriptive measures of events associated with musical features and applied to measures of their modeled expectation, from the corpus (e.g., inputs 110).

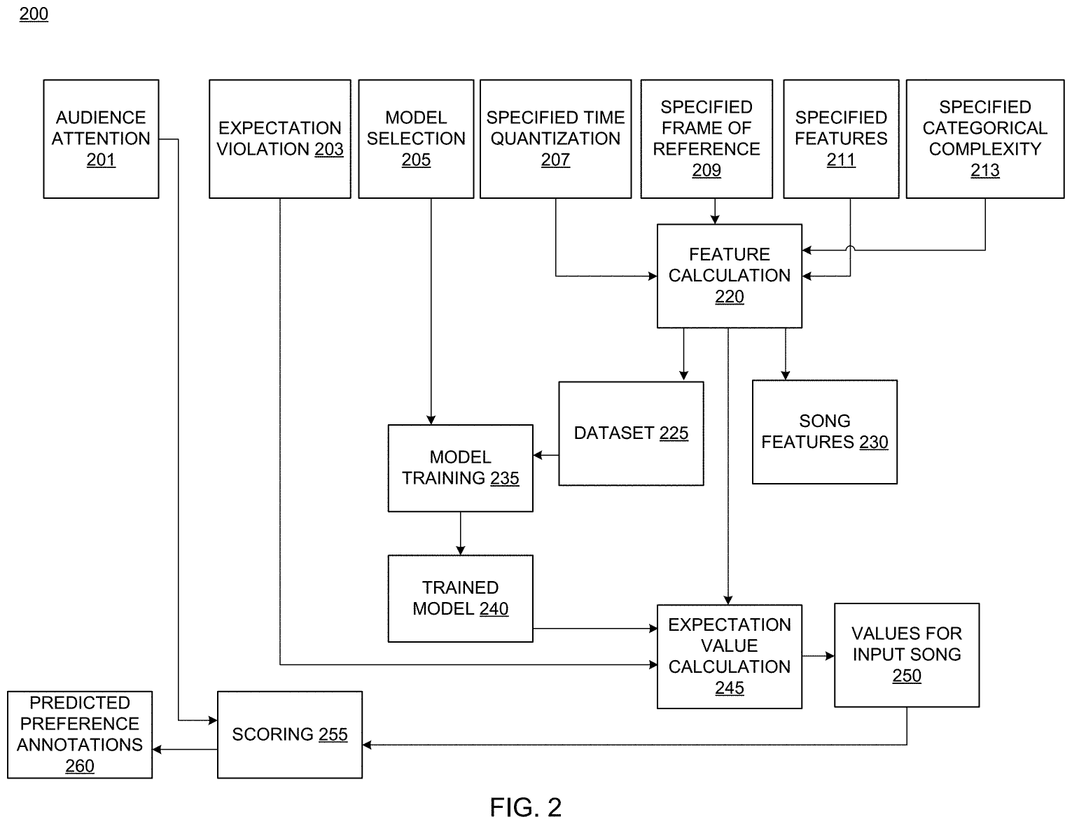

FIG. 2 illustrates a process flow 200 of combining aspects of the computing system 100 of FIG. 1 (e.g., for computing several orders of modeled expectation across several features of music within a corpus of music) according to one or more embodiments. The process flow 200 is exemplary to provide a context within which the computing system 100 may be combined. In this regard, FIG. 2 shows an overview for the processing of a target piece of music (e.g., the target piece musical information 111) and calculation of predicted preference annotations.

As shown in process flow 200, a set of inputs are received or provided to the determination engine 101. The set of inputs include audience attention 201, expectation violation 203, model selection 205, specified time quantization 207, specified from of reference 209, specified features 211, and specified categorical complexity 213.

At block 220, a feature calculation is performed by the determination engine 101 on the specified time quantization 207, the specified from of reference 209, specified features 211, and the specified categorical complexity 213, which outputs a dataset 225 of observations of sequences of feature calculations and song features 230. In an example, the determination engine 101 computes metrics for events associated with several interdependent features in the music.

At block 235, the determination engine 101 trains the selected model (205) and to generate a trained model 240. For instance, the determination engine 101 calculates models of the dynamic, interactive relationships among events associated with the features themselves and among modeled expectation of such events, incorporating inputted information about historical preference and the intended audience associated with a given prediction. Once these models are calculated, along with principles established in music cognition research, inform the generation of detailed reports about predicted music enjoyment for target pieces of music.

At block 245, the determination engine 101 utilizes the trained model 240, the expectation violation 203, and any results of the feature calculation 220 to implement an expectation violation calculation. The determination engine 101, which can use assumptions of the dataset 225, outputs from the expectation violation calculation a context and an output of expectation violation values (e.g., values for input song 250). For instance, the calculation of expectation violation, events (characterized according to levels of specificity of category and time) are evaluated according to several frames of reference that might be expected to occur. The calculation of expectation depends on, among other factors, the likelihood of any specific event to occur. To arrive at an overall measure of likelihood, measures according to several different frames of reference are considered and weighted according to their relative salience and relative contribution to variance in corpus preference information 115 associated with representative pieces of music. Five of these are described herein. A corpus-wide 113 frame of reference includes a wide range of pieces of music, broader than any one genre, time-period, or artist. A time-period-dependent 131 frame of reference focuses calculations on pieces released during a specific time-period, i.e. recent months or year. An audience-dependent 115 frame of reference is determined by selecting only pieces of music within the corpus that are labeled similarly to the target piece. An artist-dependent 132 frame of reference is used to calculate expectation violation based upon the likelihood of any event to occur within pieces from the corpus associated with the same artist as the target piece. A within a piece of music 133 frame of reference is used to calculate expectation violation based upon the likelihood of any event to occur given either previous events in the piece itself, or simultaneously occurring events within the piece.

At block 255, the determination engine 101 can provide a scoring based on the audience attention 201 and the context and the output of expectation violation values 250, which further results in predicted preference annotations 260. In this regard, the determination engine 101 can process the corpus (e.g., inputs 110) to establish expectation standards, determine a target input (e.g., a piece of music or portion thereof, such as in a MIDI file, an audio file, a transcription format, or any other format), and to generate an output. The output (e.g., preference model information) can be presented by the determination engine 101 as a score across time throughout a duration of the target input for each feature (e.g., presented as a weighted composite of the scores computed according to each order of expectation). The output can also be presented by the determination engine 101 as a single composite modeled preference score for each piece of music of the corpus (e.g., inputs 110) based on the expectations of an intended audience, within a geographic region or generally. Additionally, the output may be presented (e.g., by the determination engine 101) at any level of organization including a score across time during the piece of music for each individual instrument track for each feature for any given intended audience, and the like, up to a single binary judgment, as well as everything in between. Also, two additional measures of preference are added to complement the original provisional application measure of “chart position”. These additional measures may include “streaming data,” “behavioral data,” data from physiological studies, neuroimaging studies, electro-physical studies, or any other indicator of preference.

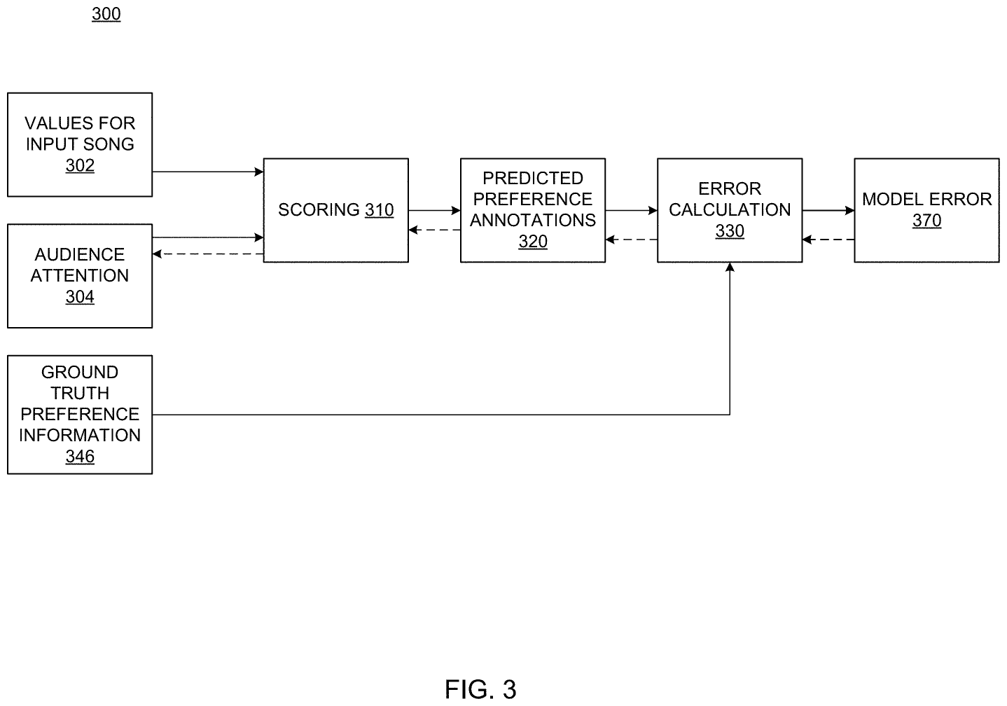

FIG. 3 illustrates an alternative flow 300 with respect to the scoring block 255 of the process flow 200 of FIG. 2 according to one or more embodiments. The process flow 300 begins by values for input song 302 (e.g., the context and the output of expectation violation values) and an audience attention 304 being provided to a scoring operation at block 310. Then, predicted preference annotations 320 are provided to an error calculation at block 330, which further uses ground-truth preference information and provides a model error 370 (e.g., this feed forward calculation of error and back propagation of error is used to adjust and refine attention). FIG. 3 also includes some feedback flow (see dashed arrows) used for computing several orders of modeled expectation across several features of music within a corpus of music.

Returning to FIG. 1, according to one or more embodiments, the determination engine 101, at every level of analysis, and in the output provided to the user, can calculate and represent information at one or more (e.g., several) timescales. Four of these timescales are described herein. An absolute timescale 151 describes the number of minutes, seconds, and milliseconds after the onset of the piece, and between events in the piece. A relative timescale 152 describes a fraction of the piece, such that every musical piece should have the same duration. A musically relevant timescale 153 describes the piece in units that are useful in understanding its rhythmic structure. Such units include measures and beats. A section timescale 154 breaks a piece into section labels, such as “chorus”, “verse”, “bridge”, etc.; ordered, such as “first”, “second”, “third”, etc.; and combinations (ordered section labels).

In the calculation of expectation violation (e.g., block 245 of FIG. 2), events are characterized in different levels of specificity of category 160. This allows the engine to determine how likely the violations are to occur, according to a representative corpus. At high levels of categorical specificity, events are much more granularly described, but are less likely to occur. At low levels of categorical specificity, events are more generally described and are more likely to occur.

The specificity of time 170 is also characterized in different levels in the calculation of expectation violation (e.g., block 245 of FIG. 2). The wider a time window is in the consideration of what is “an event”, the less likely the content of that time window is to be expected in the overall corpus. The narrower a time window, the more likely an event is to be highly expected.

As input from information about a corpus of music (including information about music and preference) is provided, the determination engine 101 identifies and calculates extensive metrics precisely describing each piece of music in the corpus along various features, in a temporal pattern throughout the duration of the piece. Such features include, but are not limited to: harmony, melody, rhythm, timbre, texture, dynamics, and lyrics. Given an intended audience and other information about goals associated with the target for prediction, the engine determines the relative significance (attention), for any further calculations, of the metrics identified. In this determination, the determination engine 101 also incorporates measures of preference within the corpus.

The determination engine 101 then calculates expectation violation according to several frames of reference, across the various features, for different sections of the audio signal, across time according to different scales of measurement, and according to different levels of specificity in time and categorical complexity. Preference data is used during some of these calculations. One reason that preference data is used here is because it reflects measures of exposure.

Throughout the described steps, there is constant recalculation of the attentions applied to the information involved. Given information about preference for the pieces of music in the corpus, and given an intended audience for a target piece of music (e.g., target piece musical information 111), the determination engine 101 incorporates, adjusts, and refines attentions associated with the results, with the goal of determining ideal ranges (and attention) of quantitative measures to predict preference. These measures include both those of raw features and those of expectation violation. Crucially, this process of adjusting and refining attentions to determine ranges for prediction incorporates as much information as possible associated with how music is perceived. This makes the resulting models and predictions much more robust and reliable than any model incorporating information about any one feature alone.

Given a target piece of music (e.g., the target piece musical information 111), the determination engine 101 analyzes all relevant information about it and calculates how well it meets the ranges for ideal raw features and ideal expectation violation along these features. The determination engine 101 then outputs a report at the desired level of specificity.

Expectation violation calculations within the frame of reference of “events within that specific piece of music” can include a wide range of dependencies. For example, the determination engine 101 can refine attentions or calculate expectation violation based on information about events occurring earlier in the piece of music within the same feature. Alternatively, the determination engine 101 can refine attentions or calculate expectation violation based on events occurring earlier or even simultaneously within some other feature or combination of features.

To the extent that the determination engine 101 bases measures of expectation violation on exposure, preference data can serve to inform proxy measures of exposure. The preference data can also be used to fine tune attention calculations of how important different metrics of features and sub-features, and how important different measures of expectation violation are with regard to these features and sub-features, in determining the overall predictive model.

Given information about preference for the pieces of music in the corpus, and given an intended audience for a target piece of music, the determination engine 101 incorporates adjusts and refines attentions associated with the results of all calculations, with the goal of determining ideal ranges (and attention) of quantitative measures to predict preference. These measures include both those of raw features and those of expectation violation. Adjusting and refining attentions to determine ranges for prediction incorporates as much information as possible associated with how music is perceived. This makes the resulting models and predictions much more robust and reliable than any model incorporating information about any one feature alone.

To provide a more detailed understanding of the determination engine 101, “Hallelujah” by Leonard Cohen (dated 1984) is provided as an exemplary piece of music input into the determination engine 101. The target piece musical information 111 of the target piece is defined as “audio file of ‘Hallelujah’ performed by Leonard Cohen.” The target piece audience information 112 can be defined as “listeners of lyrically profound, spiritual but irreverent music (from such artists as Leonard Cohen, Bob Dylan, Paul Simon, and Lou Reed).” The time period for time-period-dependent analysis 131 is defined as “two years before piece of music released (1982-1984).” This is an assignment for the value of the time period itself, not for the time-period-dependent analysis 131.

Through examination of overlap between the target piece audience information 112 and the corpus audience information 114, the overall corpus is subdivided into several, non-mutually exclusive smaller corpora to be incorporated into each of the analyses of raw measures of events and into each of the analyses of measures of expectation violation according to the five expectation violation frames of reference 113-132. The analysis of expectation violation according to the corpus-wide 113 frame of reference includes far more pieces of music than at any other frame of reference, and might contain all pieces in the corpus. The analysis of expectation violation according to the time-dependent frame of reference 131 includes all pieces of music from the overall corpus released between the years 1982 and 1984. The analysis of expectation according to the audience-dependent frame of reference 115 includes all pieces of music from the overall corpus with corpus audience information 114 consistent with the label “listeners of lyrically profound, spiritual but irreverent music (from such artists as Cohen, Bob Dylan, Paul Simon, and Lou Reed).” The analysis of expectation violation according to the artist-dependent frame of reference 132 includes all pieces of music from the overall corpus released by Leonard Cohen. The analysis of expectation according to the within a piece of music frame of reference 133 includes all events that occur either prior to or simultaneous with any event being examined for expectation violation within the target piece musical information 111 —Leonard Cohen's ‘Hallelujah.’

The determination engine 101 performs several analyses to compute both raw measures of events and measures of expectation violation, of all pieces within each of the corpora that had been subdivided according to expectation violation frames of reference 130. For each of the frames of reference 130, expectation violation is computed using several different mathematical approaches described herein. For each piece being considered in the analysis, the corpus musical information 113 of that piece is first automatically separated into five different sets of instrument-separated information 140, and also retained as an intact piece of music for a separate analysis of the full musical information 113 of that piece in the corpus.

Using several methods described herein, both raw measures of events and measures of expectation violation are exhaustively calculated, along the duration of each piece of music, at each permutation of all information for each piece of music in the various subdivided corpora at each expectation violation frame of reference 130, for each set of instrument-separated information 140, according to each of the seven features 120, at each of the timescales 150, at each of the levels of specificity of category 160, and at each level of specificity of time 170.

A model is then computed through an iterative process of refining attentions for the combination of all calculations, optimized to represent the most robust correlative relationship possible within the data among the results of these calculations and corpus preference information 115 associated with the corpus musical information 113 from each piece of music being considered in each analysis.

The refined attentions are then applied to both raw measures of the target piece musical information 111 across the duration of each piece, along all permutations of each expectation violation frame of reference 130, for each set of instrument-separated information 140, according to each of the seven features 120, at each of the timescales 150, at each of the levels of specificity of category 160, and at each level of specificity of time 170. The result of this process is an ‘ideal’ range of values, for each feature, at each time across the duration of a piece, associated with high preference across a corpus representing the target piece musical information 111—‘Hallelujah.’

The engine then provides an output, such as a report that can include detailed information about predicted preference of ‘Hallelujah’ according to raw measures of events across the duration of the target piece musical information 111 and predicted preference of the piece according to measures of expectation violation across the duration of the piece. The report can also integrate this information at any level of organization the client prefers. Such integration would be the result of further refining attentions to calculate the precise extent to which all factors are likely to interact in the brains of listeners to lead to preference formation. This information can reflect a weighted collapsing of the output information across any of the factors 120, a weighted collapsing of the output information tracked along the duration of the piece down to a single measurement for the entire piece, or both.

After features 120 have been calculated, as described expectation is calculated and the violation of expectation. Each method of surprise calculation generally to be agnostic to the particular feature used, the specificity of the data used in model fitting, and the time quantization and categorical complexity involved in calculating. Each method is generally defined with the assumptions of an input of a dataset, D, of observations of sequences of feature calculations F from a set of pieces of music to give context and an output of expectation violation values, EV[t], for a particular time, t, input piece of music. Additional detail about how D is chosen is also set herein and as seen in Equation 1.

D=(F[t], . . . ,F[t−L]): specificity(piece of music)=s, piece of music∈C,(L−1)≤t≤length(piece of music) Equation 1

All three approaches above require the same input and output described above. The input is always a data set, D, of sequences of length L that abide by a certain specificity, s. The output is the corresponding EV time series values of a piece of music. This piece of music may or may not be included in the data set used for model fitting. Defining specificity requires filtering only pieces of music that have certain metadata. Specificity can include restrictions on time period (e.g., all time or 131-present), audience/genre, and artist/piece of music specific data. The set of all pieces of music is denoted as C. While specificity includes restrictions on what pieces of music are included in D, category and time quantization method adjust the nature of F[t] and t itself.

As described above, time quantization, or levels of specificity of time 170, includes absolute, relative, and tempo/beat quantization. In absolute time, t corresponds to a particular seconds/ms value. Length(piece of music) is variable based on sampling rate, fs, (i.e., t=1=>0 seconds, t=2=>1/fs, . . . , t=i=>i/fs). In relative time, pieces of music are divided into W equally sized windows. Windows may overlap as well. (i.e., t=1=>(0%-1/W %) of piece of music, t=i=>(i/W %-i1/W %) of piece of music). In tempo/beat quantization, t corresponds to a particular number quantization level, Q, at the note (e.g. eighth note), beat, measure or a grouping of measures. (i.e., if Q=1 beat. t=1=>beat 1, t=2=>beat 2, etc., . . . ).

While the time quantization method represents variation in the meaning of t, feature categorical complexity represents all variation in F[t]. This is heavily dependent on the feature, and not all features will have variation in category. One example of feature categorical complexity is chosen when looking at the feature of harmonic expectation violation. Here, feature categorical complexity can be a maximum degree of the chord included (e.g., 5th being triad v. 13th).

There are several general approaches to expectation violation calculation including, but not limited to: Shannon Information Theory, Signal Distortion Estimation, and Kolmogorov Complexity.

For example, in the Shannon Information Theory Approach, an Lth order probabilistic model of expectation, y, is trained as shown in Equation 2.

y[t]=P(F[t]|F[t−1], . . . ,F[t−L]) Equation 2

With this model of expectation, y, expectation violation, EV, is calculated with Shannon information as seen in Equation 3.

EV[t]=−log(y[t]) Equation 3

These models may vary in sophistication based on the nature of the feature. Two different examples may illustrate this concept of a model for y based on a particular feature, F.

In the first example, the modeling of expectation of melody is performed. In this example, MIDI is a natural choice. To model y, the “n-gram” model is used, since it is built for discrete data like MIDI. A list of sequences of melody lines or grams, g, in a corpus of length n is created. Then, a maximum-likelihood estimation process is used to calculate the probability of that sequence. Let g[t] be the gram at time t represented by an array of note observations, F, of length n, as seen in Equation 4. Maximum-likelihood estimation is a method of estimating the parameters of a probability distribution by maximizing a likelihood function, so that under the assumed statistical model the observed data is most probable.

g[t]=(F[t],F[t−1], . . . ,F[t−n−1]) Equation 4

The set of all grams observed at least once in a subcorpus, D, is defined as τD. The count function c(x) is defined as the amount of times x appears in τD, as seen in Equation 5.

y[t]=P(F[t]|F[t−1], . . . ,F[t−n−1])=P(g[t])=c(g[t])/∈τc(l) Equation 5

In a second example, the focus is on the modeling of expectation of Tempo. Here F[t] is a continuous value representing the tempo of a piece of music at a particular time, t. A recurrent neural network (RNN) is trained to model the function. This RNN can be trained with a great number of parameters significantly higher than the length of time of the sequences.

These two examples highlight a large range of model complexity. The first method for melody uses a simple n-gram model with no learned parameters. The second method for tempo uses a sophisticated recurrent neural network that can easily have millions of parameters. Other models used include convolutional neural networks, Markov models, hidden Markov models, and conditional random fields.

In the Signal Distortion Estimation method of expectation violation, instead of using an information theoretic approach, signal distortion from expectation may be useful. The set-up of F[t] as described above is used, but instead of modelling y[t] as a probabilistic approach, the expected value may be learned directly, as seen in Equation 6.

y[t]=E(F[t]|F[t−1], . . . ,F[t−L]) Equation 6

An advantage of this approach is there is no need to model probabilities directly. Instead, the expected output is considered and an appropriate distance metric is used to measure expectation violation.

As an example, a linear predictive coding (LPC) is used as a model to directly predict F[t] based on past values. Using this auto-regressive model would be impossible with the Shannon information theory approach since it is not probabilistic. An appropriate distance metric, d(.,.), is chosen to compare F[t] and y[t]. When F[t] is a continuous 1D variable (e.g. tempo), absolute difference may be appropriate, as seen in Equation 7.

EV[t]=d(F[t],y[t])=|F[t]−y[t]| Equation 7

For vectors, an L2 norm of the difference vector ∥·∥ may be more appropriate, as seen in Equation 8.

EV[t]=d(F[t],y[t])=∥F[t]−y[t]∥ Equation 8

For discrete data, a custom distance metric may be used. For example, if F[t] is a word token whose predicted token was y[t], pre-trained continuous word embeddings w(·) may be used. Typically, similarity between word embeddings is best represented by a cosine distance, as seen in Equation 9.

EV[t]=d(F[t],y[t])=cos(∠w(F[t]),w(y[t]))=w(F[t])w(y[t])∥w(F[t])∥∥w(y[t])∥ Equation 9

Algorithmic information theory proposes ways to measure the amount of information in a sequence by estimating the complexity needed of the algorithm that generated it. In particular Kolmogorov Complexity may be used, as seen in Equation 10. This is defined as a minimum length of a program needed to generate a sequence, g, having observed a dataset of length L sequences from a given corpus. Such an approach is used with feature data that has discrete representation. While the Kolmogorov Complexity is not computable in all cases, for sufficiently short sequences, it may be estimated.

EV[t]=K(g[t]|D) Equation 10

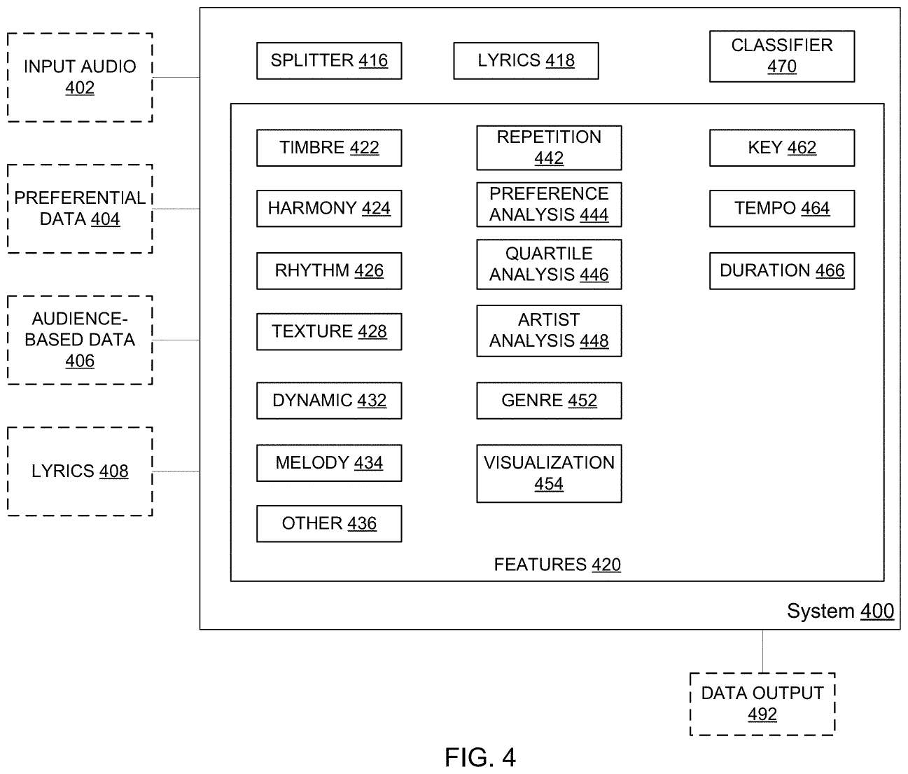

Turning now to FIG. 4, a system 400 for computing orders of modeled expectation across (several) features of music within a corpus of music is shown according to one or more embodiments. The system 400, which is an example of the determination engine 101 of FIG. 1, provides an estimate of the popularity of a piece of music. The system 400 achieves this conclusion based on an analysis of one or more features of the piece of music. Some of the features that may be analyzed are done so on the piece of music level, while others may be performed on certain tracks. A database of pieces of music is included in the system 400 with each analyzed based on the same or similar features described herein. These pieces of music are noted because of their known success in the marketplace and preference information. This success may be identified as described herein. In short, the success of these pieces of music in the database may be determined based on a music chart, downloads, online streams, and the like. Correlations may be found between the success of respective pieces of music in the database and that specific piece of music corresponding features enabling a relationship to be created between features and ultimate success. As would be understood by those possessing an ordinary skill in the art, success may not be set by a single path or a single feature. Instead, success may be determined by a weighting of the measured features found herein.

The absolute surprise of a piece of music may be calculated by determining the surprise of finding each feature of the piece of music and averaging, or weightedly combining, the outcome of the feature analysis.

The analysis of each feature of a piece of music is described herein. The features include, by non-limiting example, only, track-level features, such as timbre, harmony, rhythm, texture, dynamics, and melody, piece of music-level features, such as key, tempo, duration, and lyrics.

Once all the raw features are obtained, they are weighted and combined to produce an overall score for the work. This score represents how popular the algorithm expects the piece of music to be. Attention is based on a corpus of charting information (e.g., Billboard and Spotify pieces of music). Within this corpus, a calculation the raw feature values for each piece of music, and also record the charting information statistics. An analysis is performed across four perspectives, including over all the pieces of music within one genre, over all the pieces of music by one artist, over all the pieces of music starting in a defined year and continuing to the present day, and over all the pieces of music in the corpus.

Inputs to the system 400 include an input audio 402, preferential data 404, audience-based data 406, and the input lyrics 408, or written word.

The input audio 402 may include and input musical information, such as a piece of music or pieces of music, in any form. This may include input acoustic audio, transcription, MIDI, tags and other piece of music information. MIDI is a technical standard that describes a communications protocol, digital interface, and electrical connectors that connect a wide variety of electronic musical instruments, computers, and related audio devices for playing, editing and recording music. As is understood a single MIDI link through a MIDI cable can carry up to sixteen channels of information, each of which can be routed to a separate device or instrument. This can be sixteen different digital instruments, for example. MIDI carries event messages, data that specify the instructions for music, including a note's notation, pitch, velocity (which is heard typically as loudness or softness of volume), vibrato, panning to the right or left of stereo, and clock signals (which set tempo).

The preferential data 404, such as charting information statistics, and referred herein interchangeably, refers to data indicating musical preference or behavioral data regarding the music as a society. This data includes information regarding the acceptance of music and pieces of music.

The preferential data 404, from the charting information statistics may include debut chart date, debut chart position, number of weeks on chart, peak chart position, average chart position, ending chart date, ending chart position. This information may be obtained as an input. The system 400 calculates the statistics as follows: debut chart date which is the first date that the piece of music appears on the charts; and debut chart position which is the first position that the piece of music appears on the charts; number of weeks on charts, number of instances the piece of music appears on the charts. This is not just the number of weeks between the ending chart date and the beginning chart date, since it is possible for a piece of music to go off the charts for a while and then return. The information may be further calculated by the system 400 as follows: peak chart position which is the best (smallest position) value of all the chart positions that the piece of music appears on the charts; average chart position which is the average of all the chart positions, rounded to the nearest whole number, that the piece of music appears on the charts; ending chart date which is the last date that the piece of music appears on the charts; and ending chart position which is the last position that the piece of music appears on the charts. After the statistics are calculated, the statistics may be matched to the audio files. The audio files are from the input audio 402 and in an exemplary embodiment may be input from .mp3 audio files.

The audience-based data 406, such as genre statistics, provides information regarding classification of music or pieces of music within a genre, and generally the audience perception and behavior associated with that genre. Audience-based data may also include other details on pieces of music that particular, or groups, of audience members also liked.

The input lyrics 408 may include any form of lyrics for pieces of music. This may include lyrics for the piece of music to be measured and may include lyrics for all pieces of music used in preference analysis. The input lyrics 408 may include information from a database that has reliable lyric information, linked to timepoints within each piece of music, the scrubbing of information from online sources of lyric information, or from automatic speech-to-text software.

As shown in FIG. 4, the system 400 can includes a splitter 416, lyrics 418, and features 420. Features 420, such preference features, may be determined in a number of categories. Features 420 may be used to quantify the preference for a piece of music in order to compare the success of the piece of music in analyzing the tracks and elements of the piece of music. Features in tracks, or stems, include timbre 422, harmony 424, rhythm 426, texture 428, pitch or dynamics 432, melody 434, and other track level features 436. Features 420 may include repetition 442, preference analysis 444, quartile analysis 446, artist analysis 448, genre 452, and visualization 454. Features 420 allow for a quantization of the overall preference or reception of a piece of music in order to correlate the underlying elements in the piece of music to the ultimate value of the piece of music. In addition to the features 420 including preferences, additional features may be collected on the full piece of music. These include piece of music level features that add to success of the piece of music. For example, key 462, tempo 464, and duration 466 all may affect how pieces of music are viewed. Other categories of features 460 (not illustrated in FIG. 4) include danceability and groove and may be additionally found in other applications of the music world, including but not limited to applications that provide music to listeners.

Repetition 442 allows for an examination of veridical expectations within pieces of music and across pieces of music. Veridical expectations within pieces of music are calculated by examining instances of specific patterns that repeat, possibly with small changes that can be smoothed out. Specifically, patterns that have already occurred in a particular piece of music. Veridical expectations across pieces of music are calculated by examining specific patterns that repeat. Specifically, patterns that have occurred in pieces of music that precede a particular piece of music in release date, and perhaps more narrowly, in pieces of music within the same genre. One common method for finding repeated elements is first extracting a feature such as chroma which varies from point to point in a piece of music, and using a self-similarity matrix to find instances where different sections of the piece of music are very similar. An approach for using created audio thumbnails may be useful. This technique may operate when the repeated segments differ in some capacity, as shown by the Muller paper, incorporated herein by reference as if set forth in its entirety. The relationship between veridical expectations and preference is the inverse of the relationship between the other (schematic) expectations and preference.

Preference analysis 444 examines the preferential information and establishes correlation between the acceptance of the piece of music, such as charting, with other expectation features, for example, features (tracks and/or piece of music) 420 and the lyrics 418. The preference analysis 444 provides feedback on the component of the piece of music that lead to the success of the piece of music.

Quartile analysis 446 may be performed on the charting information. This analysis may include the approach from “A Statistical Analysis of the Relationship between Harmonic Surprise and Preference in Popular Music” by Scott A. Miles, David S. Rosen, and Norberto M. Grzywacz (2017), incorporated herein by reference as if set forth in its entirety, (herein referred to as “Miles et al. 2017”). Artist analysis 448 may be designed to minimize potential confounds that may be introduced along with differences between artists. The analysis involves parallel comparisons, each one performed on pieces of music released by one artist with various levels of preference. According to one or more embodiments, note that quantitative measures of preference (i.e. On-demand streams in first 4 months after release) are modeled using regression, while discrete measures of achieving a particular goal (e.g., making it to the Billboard Hot 100) are modeled using classification.

Genre 452 may be analyzed using a reliable database which may be created or accessed to categorize the genres of all the pieces of music in the analysis. This categorization may allow for further analyses using isolated segments of the corpus to identify effects that are exhibited more strongly across some genres than others. Genre 452 for each piece of music is obtained and used to compare the audio file tokens to tokens derived from a playlists that were used to obtain the audio in the first place.

Key 462 includes the key that the piece of music is created in and how that key correlates with other pieces of music of similar style. As will be discussed in more detail herein, the estimated key is calculated and may be genre-agnostic. The estimated key may provide the probability of each key along with the key itself, and that probability can be used as an indicator of confidence.

Tempo 464 includes the tempo of the piece of music. This tempo may be important to its reception by listeners. Tempo is calculated using dynamic programming as described in more detail herein. That is, the system first calculates an onset signal, defined as a signal that can be expected to have large values at beat positions and then calculates a global tempo using the onset signal's periodicity. Tempo 464 is designed to calculate the length of each individual audio file by dividing the calculated length by the audio sample rate to determine the duration 466.

The system 400 includes a splitter 416 to separate the piece of music into tracks or elements. This allows each of the elements to be analyzed independently. A score/weighting profile may be used across the elements, and may also allow for weighting of one element over another element, for example.

The splitter 416 splits audio, by way of example, by before calculating the features for each window, the audio is split into five stems: bass, drums, piano, vocals, and ‘other.’ The splitting is done using the Python package spleeter. Spleeter is built on tensorflow, an open source library for machine learning applications. The developers of spleeter created modified 12-layer CNN models, called U-Net models, of the various stems they wanted to isolate (bass, drums, piano, and vocals). U-Nets are mostly the same as standard encoding-decoding CNNs, but U-Nets additionally include ‘skip’ connections that allow for some layers to be skipped. This skipping enables a better ability to deal with audio jitter. Separation of a mixed audio track is performed by masking the mixed input audio with soft masks created by the U-Nets for each stem. Additional stems may also be used, as well as an entirely new and contained stem model enabling the ability to view and calculate across these additional stems.

The result of the splitting in the splitter 416 is the creation of up to 5 stem audio files, one for each stem, all the same length as the original audio file and ideally containing the audio contributed by one instrument or source. For instance, the ‘drums.wav’ stem would, in theory, contains the drum sounds for a given file, with everything else essentially muted. Each other stem file is created in a similar fashion. In the case of the system 400 not detecting a representation of a given stem in the splitter 416, the splitter 416 may not create a file. So for instance, if for a given piece of music the system cannot find any piano signal, there won't be a ‘piano.wav’ file in the output stem folder. Additional information is provided in “Spleeter: a Fast and State-of-the-Art Music Source Separation Tool with Pre-Trained Models,” by Romain Hennequin et al., which reference is incorporated by reference as if set forth in its entirety herein.

Currently, the system 400 operates using relative windows with a size of 1/128 of the audio, and a hop of 1/1024 of the audio. There are thus 1017 equally-sized and equally-spaced windows within each piece of music, but the windows may vary in size between pieces of music.

Pitch is an aspect of a sound that may be discerned. For example, when reflecting on one musical sound, ability exists to identify whether the note or tone is “higher” or “lower” than another musical sound, note or tone. The highness or lowness of pitch may include the way a listener hears a piercingly high piccolo note or whistling tone as higher in pitch than a deep thump of a bass drum. Pitch may also refer to, in the precise sense, those associated with musical melodies, basslines and chords. Precise pitch may be determined in sounds that have a frequency that is clear and stable enough to distinguish from noise.

A melody 434, also called a “tune,” is a series of pitches, or notes, sounding in succession (one after the other), often in a rising and falling pattern. The notes of a melody are typically created using pitch systems, such as scales or modes. Melodies also often contain notes from the chords used in the piece of music.

Harmony 424 refers to the “vertical” sounds of pitches in music, which means pitches that are played or sung together at the same time to create a chord. Harmony means the notes are played at the same time, although harmony may also be implied by a melody that outlines a harmonic structure (i.e., by using melody notes that are played one after the other, outlining the notes of a chord).

Rhythm 426 is the arrangement of sounds and silences in time. Meter animates time in regular pulse groupings, called measures or bars, which in Western classical, popular and traditional music often group notes in sets of two (e.g., 2/4 time), three (e.g., 3/4 time, also known as Waltz time, or 3/8 time), or four (e.g., 4/4 time). Meters are made easier to hear because pieces of music and pieces often, but not always, place an emphasis on the first beat of each grouping.

Texture 428 (musical texture) is the overall sound of a piece of music or piece of music. The texture 428 of a piece or piece of music is determined by how the melodic, rhythmic, and harmonic materials are combined in a composition, thus determining the overall nature of the sound in a piece. Texture 428 is often described in regard to the density, or thickness, and range, or width, between lowest and highest pitches, in relative terms, as well as more specifically distinguished according to the number of voices, or parts, and the relationship between these voices. For example, a thick texture 428 contains many ‘layers’ of instruments. One of these layers can be a string section, or another brass. The thickness also is affected by the amount and the richness of the instruments. Texture 428 is commonly described according to the number of and relationship between parts or lines of music. For example, monophony refers to a single melody or “tune” with neither instrumental accompaniment nor a harmony part. A mother singing a lullaby to her baby would be an example.

Heterophony refers to two or more instruments or singers playing/singing the same melody, but with each performer slightly varying the rhythm or speed of the melody or adding different ornaments to the melody. Two bluegrass fiddlers playing the same traditional fiddle tune together typically each vary the melody a bit and each add different ornaments.

Polyphony refers to multiple independent melody lines that interweave together, which are sung or played at the same time. Choral music written in the Renaissance music era was typically written in this style. A round, which is a piece of music such as “Row, Row, Row Your Boat”, which different groups of singers all start to sing at a different time, is a simple example of polyphony.

Homophony refers to a clear melody supported by chordal accompaniment. Most Western popular music pieces of music from the 19th century onward are written in this texture 428.

Timbre 422, sometimes called “color” or “tone color” is the quality or sound of a voice or instrument. Timbre 422 is what makes a particular musical sound different from another, even when they have the same pitch and loudness. For example, a 440 Hz A note sounds different when it is played on oboe, piano, violin or electric guitar. Even if different players of the same instrument play the same note, their notes might sound different due to differences in instrumental technique (e.g., different embouchures), different types of accessories (e.g., mouthpieces for brass players, reeds for oboe and bassoon players) or strings made out of different materials for string players (e.g., gut strings versus steel strings). Even two instrumentalists playing the same note on the same instrument (one after the other) may sound different due to different ways of playing the instrument (e.g., two string players might hold the bow differently). The physical characteristics of sound that determine the perception of timbre include the spectrum, envelope and overtones of a note or musical sound.

Expressive qualities are those elements in music that create change in music without changing the main pitches or substantially changing the rhythms of the melody and its accompaniment. Performers, including singers and instrumentalists, may add musical expression to a piece of music or piece by adding phrasing, by adding effects, such as vibrato with voice and some instruments, such as guitar, violin, brass instruments and woodwinds, dynamics, such as the loudness or softness of piece or a section of it, tempo fluctuations, such as ritardando or accelerando, which are, respectively slowing down and speeding up the tempo, by adding pauses or fermatas on a cadence, and by changing the articulation of the notes (e.g., making notes more pronounced or accented, by making notes more legato, which means smoothly connected, or by making notes shorter).

Expression is achieved through the manipulation of pitch, such as inflection, vibrato, slides, and the like, volume, such as dynamics, accent, tremolo, and the like, duration, such as tempo fluctuations, rhythmic changes, changing note duration including with legato and staccato, and the like, timbre, such as changing vocal timbre from a light to a resonant voice, and texture, such as doubling the bass note for a richer effect in a piano piece. Expression therefore can be seen as a manipulation of all elements in order to convey “an indication of mood, spirit, character, etc.” and as such cannot be included as a unique perceptual element of music, although it can be considered an important rudimentary element of music.

Looking at each of these elements in turn. Each voice in the MIDI transcriptions is on its own channel. To calculate changes in timbre 422, which is described in the Wallmark paper, each section is analyzed, and the total number of units (units may be sixteenth notes, eighth notes, quarter notes, half notes, or whole notes with separate analyses for each resolution) that are occupied by a sound within that section. The maximum possible total number of units is the number of MIDI channels in the piece of music multiplied by the number of units in the section. That total number of occupied units becomes the denominator for the analysis.

Once the total number of occupied units is calculated, the same type of “occupied units” calculation is performed for each MIDI channel. The per-channel occupied units value for each given MIDI channel (the numerator) is then divided by the total value to arrive at a relative value for occupied units for each MIDI channel. This results in a decimal value of relative occupied units (<1) from each channel. If added together, the relative values for occupied units from all channels in a given section will always add up to 1.0.

The relative values for each of the MIDI channels in the pre-chorus “section” for each MIDI channel, are then compared to the corresponding relative values for that MIDI channel in the chorus “section”. The result of the comparisons is a set of positive differences in relative values (from subtracting the relative occupied unit value of “chorus” from that of “pre-chorus” for each corresponding MIDI channel) and a set of negative differences in relative values. As the sum of the positive differences and the sum of negative differences is zero, only the positive differences may be retained, and summed to reflect a change in timbre across successive sections.

MIR features may also, either alternatively or additionally, to calculate timbre 422 based on audio. Possible approaches include using the timbre-sensitive features discussed by Antoine and/or Farbood, and using the timbral norms discussed in the Lavengood dissertation. The MATLAB Timbre Toolbox and the MIR Toolbox includes the features used in the Farbood paper. As for Python, a software library called LibRosa has three of the five features used in the Farbood paper (spectral centroid and flatness), although the system 400 incorporates all five.

Finally, tension is also linked to timbre 422, and by calculating tension and incorporating that into a timbre analysis, one can derive a better understanding of the overall musical work.

Specifically, and as will be described herein, for a section, a denominator is calculated by counting the total number of units in all channels which contain at least one note. For each channel in a section, a numerator is calculated by counting the number of units in which that channel which contains at least one note. The timbre 422 of that channel in that section is found by taking that channel's numerator and dividing by the denominator. Differences between the channel-wise timbre 422 in different sections can then be calculated, as seen by Equation 11, where ‘TM’ is timbre, ‘c’ is the channel index, ‘s’ is the section index, ‘C’ is the number of channels with at least one occupied unit, and Uc is the number of occupied units in a given channel c.

$$T {M}_{c , s} = \frac{{U}_{c}}{{\sum }_{c = 1}^{C} {U}_{c}} \qquad Equation 11$$

Harmony 424 may be calculated in a number ways. Specifically, harmony 424 may include zeroth order harmony, multiple higher order harmony, and chromo rarity. Harmonic expectation violation calculations described herein may use multiple types of representations of harmony. Either symbolic features like chord symbols or signal features like chroma-spectrograms may be used. The chroma-spectrogram provides the cumulative amount of energy of all octaves of a certain note at a certain time.

In a first embodiment, harmony may be used. There are various ways to do this, including using the Chew helix model and the Krumhansl method, the latter of which is included in music. Next, using the same zeroth-order formulas used in Miles et al. 2017, entropy for each of the following chords is calculated: major triad, minor triad, augmented triad, diminished triad, power chord, sus2 chord, sus4 chord, major 7th chord, dominant 7th chord, minor 7th chord, minor/major 7th chord, diminished 7th chord, and half-diminished 7th chord. The first step in this process is identifying the “exposure” weighting of each piece of music based on chart position and number of weeks on the charting information (e.g., in the case of Billboard Hot 100 data) or cumulative streaming counts in the first ten weeks from each piece of music's release (e.g., in the case of Spotify Top 200 data). With this weighting properly estimated, the baseline corpus probability can be calculated for each unique chord by totaling up the number of times each unique chord appears in the piece of music and dividing that total by the number of all chords in the piece of music. The entropy can then be calculated from the probability. “Up to seventh” is a way of simplifying the harmony of each chord. A 9th, 11th, or 13th chord can be labeled as a 7th chord. For example, as seen in Equation 12, ‘P[c]’ is the weighted probability of chord ‘c’, ‘Ws’ is the weight of piece of music ‘s’, S is the number of pieces of music in the set, ‘Oc,s’ is the number of occurrences of chord ‘c’ in piece of music ‘s’, and C is the number of chords in the set.

$$P [ c ] = \frac{{\sum }_{s = 1}^{S} {W}_{s} {O}_{c , s}}{{\sum }_{s = 1}^{S} {W}_{s} {\sum }_{c = 1}^{C} {O}_{c , s}} \qquad Equation 12$$

The set of pieces of music may contains the pieces of music starting in the first week for which charting information is provided and ending in the week *before* the week under consideration. For example, as seen in Equation 13, S[c] is the ‘surprise’ of chord ‘c’, and P[c] is the weighted probability of chord ‘c’.

S[c]=−log 2(P[c]) Equation 13

The sections (e.g., as defined from section annotation bar indices) immediately before and immediately following the onset of each chorus may be examined. These sections may be identified by our human annotations and may serve as “pre-chorus” and “chorus”. For each section, the average zeroth-order entropy is calculated at each level of resolution (e.g., 1 beat, 2 beats, 1 measure, 2 measures, 4 measures, 8 measures, 16 measures). Each level is a completely separate analysis. Then the “contrastive surprise” is calculated in two different ways: subtracting the average entropy value of a piece of music's chorus sections from the average entropy value of its pre-chorus sections, and dividing the average entropy value of a piece of music's chorus sections from the average entropy value of its pre-chorus sections.

The absolute surprise may be examined by averaging the entropy of all chords at each level of resolution including the pre-chorus surprise at the level of 2, 4, and 8 bars prior to the chorus onset, as indicated by the section annotations.

In a separate embodiment that may be used instead of zeroth order harmony, or in addition there, higher-order entropy analyses may also be used. Such analyses include calculating Bayesian (conditional) probability rather than raw probability before calculating entropy values.

Harmonic surprise values may be calculated using the most polyphonic channel and then the system 400 takes the arithmetic mean of the harmonic surprise values in each section. For example, as seen in Equation 14, ‘H’ is the harmonic surprise, ‘N’ is the number of units in the specified section ‘s’, and ‘Sn’ is the harmonic surprise at unit ‘n’. Additionally, an IDyOM analysis (A Comparison of Statistical and Rule-Based Models of Melodic Segmentation” by M. T. Pearce, D. Mullensiefen, and G. A. Wiggins (2008), incorporated herein by reference as if set forth in its entirety, (herein referred to as “Pearce et al. 2008”) may be performed at various orders on harmonic expectation values.

$${H}_{s} = \frac{1}{N} {\sum }_{n} {S}_{n} \qquad Equation 14$$

In estimating chroma rarity by first training generative models on chromagrams. Each chromagram has 12 frequency bins (while 12 is common, chromagrams with 24, 36, etc. bins may also be used) for all notes across all octaves (e.g. A, A #/Bb, B, . . . ) where X[f,t] is the energy fth chroma bin and tth time bin. Using an auto-regressive model that estimates p(X[f,t]|X[f,t−1], X[f,t−2], . . . , X[f,t−T]) for each time bin, t, with T is the order of the model, chroma rarity is defined at timestep, t, as seen in Equation 15.

CR[f,t]=−log(p(X[f,t]|X[f,t−1],X[f,t−2], . . . ,X[f,t−T])) Equation 15

Additionally, long-term hierarchical autoregressive models look at repeating patterns within groups of time-frames. This finds rarity and information in the repeating chroma form of the piece of music (i.e., a section of the chromagram corresponding to the bridge yields high chroma rarity when most the probabilistic pattern expects a section of the chromagram corresponding to the chorus).

Rhythm 426 may be calculated using the rhythmic expectation violations (e.g., unanticipated breaches of rhythmic norms) within the melody channel of the MIDI or from a drum channel (or separated drums, if real audio is being used). The average number of note onsets per bar within the melody channel in each of the successive “sections” may be compared across sections. Bars with different numbers of note onsets than other bars within a given section may be identified, as well as sections with different numbers of note onsets in their bars than other sections.

The number of melody channel onsets in each bar in the section may be determined by taking the arithmetic mean of those numbers of onsets to get the average number of melody channel onsets per bar in the section. Identify any bars in the section which have a different number of melody channel onsets than either the average rounded down and the average rounded up (or just the average, if the average happens to be an integer). For example, as seen in Equation 16, ‘RH’ is the rhythm, ‘s’ is the section index, ‘B’ is the number of bars in the section, and ‘0’ is the number of melodic onsets in bar index ‘b’.

$$R {H}_{s} = \frac{1}{B} {\sum }_{b = 1}^{B} {0}_{b} \qquad Equation 16$$

For example, as seen in Equation 17, ‘BM’ is the list of ‘bad’ measures whose rhythmic onset counts differ from the section average, ‘Ob’ is the number of melodic onsets in bar index ‘b’, and ‘s’ is the section index. The 0 values in ‘BM’ may be removed prior to further processing.

BM_{b,s}={0O_{b}=└RHₛ┘0O_{b}=[RHₛ]b o.w. Equation 17

Melodic patterns that occur multiple times within the piece of music may be identified. For example, if such a melodic pattern is four notes long, instances where the first three notes of the previously established pattern appear but are followed (in an instance later in the piece of music) by a different rhythmic event rather than the expected fourth event may be identified. This event can be the same pitch or a different pitch, or a rest. The identified event is set up rhythmically but violates the rhythmic expectation (e.g., anticipated rhythmic norms by a listener).

Rhythmic expectation violation may be measured, especially within the drum MIDI channel. The system 400 of FIG. 4 may analyze the audio files for additional low-level rhythmic features and detection function values, such as ‘superflux’ and spectral rhythm patterns, as well as other features. The system 400 may examine higher-level rhythmic features such as syncopation and danceability, and this analysis may be coupled with genre information described herein. The system 400 may examine rhythmic repetition, for instance by using the Mel-scale transform (visualization 454 here). This gives the data a perceptual scale of pitches judged by listeners to be equal in distance from one another. Rhythmic steadiness may be monitored by using beat trackers that rely on steadiness, such as a tracker (as described with respect to “Beat Tracking by Dynamic Programming” by Daniel P. W. Ellis (2007), incorporated herein by reference as if set forth in its entirety, (herein referred to as “Ellis et al. 2007”)), and identifying any failures. Autoencoders may be used to transform rhythm into simpler spaces.

Surprise may be a deviation from the norm. Therefore, a rhythm detection (or onset detector), using superflux or another method, may be included to measure deviation from that norm at various timeframes (one measure, four measures, one section, etc.). This measurement of rhythm may be performed over time. Preferences may be examined to find the rhythm patterns of each piece of music, then check how the patterns of new pieces of music match the patterns established in pieces of music from prior weeks on the charts.

Texture 428 may be calculated by acknowledging that because texture relates to the density or thickness of the music, for texture analysis, the number of occupied units within each section is calculated for each individual MIDI or separated audio channel that is available in the entire piece of music. The standard deviation across all resulting values is then calculated. This standard deviation will represent an inverted measure of texture in the section. The more uniform distribution of occupied units across all channels, the heavier the perceived texture of the music.

For each channel in each section, the number of units in that channel occupied by at least one note is counted. The standard deviation of the counts of all the channels in the section is calculated, and that number is then inverted (i.e., raised to the −1st power). The resulting value is the texture value for that section. For example, as seen in Equation 18, ‘TX’ is texture, ‘s’ is the section index, ‘C’ is the number of channels with at least one occupied unit, ‘Uc’ is the number of occupied units in a given channel ‘c’, and ‘U’ with a bar is the average number of occupied units in a single channel. As with the other features 420, texture may be calculated using the MIR texture, either additionally or alternatively, as well.

$$T {X}_{s} = \frac{1}{\sqrt{\frac{1}{C - 1} {\sum }_{c = 1}^{C} ( {U}_{c} - \underline{U} )}} \qquad Equation 18$$

The information about dynamics 432 (loudness, approximated by Root Mean Square Energy (RMSE) as in the Purwins paper) may be determined through MIR analysis of the actual audio track. The onset of each chorus, along with the actual duration of each “section” (two, four, eight, or sixteen bars), may be labeled on the audio track in milliseconds. Through MIR, the average relative loudness value of each section is computed. Relative loudness is the average loudness level across the section, divided by the average loudness level across the entire piece of music. The values for average relative loudness may then be compared for pairs of successive sections across the onset of each chorus. For example, as seen in Equation 19, ‘D’ is the dynamics value, ‘t’ is a time window, ‘x_n’ is the value of the acoustic signal at a sample index ‘n’, and ‘N’ is the total number of samples in the specified time window.

$${D}_{t} = \sqrt{\frac{1}{N} {\sum }_{n} {\vert {x}_{n} \vert}^{2}} \qquad Equation 19$$

An IDyOM analysis (Pearce et al. 2008) may be performed for each section, with the any given section being the setup for melodic expectations and the initial note or initial few notes of any following section being the target of any expectation calculation. The ‘complebm’ function in the MATLAB MIDI toolbox, which calculates the EBM complexity of a MIDI file, on each “section” at each resolution at each duration combination. The complexity of successive sections resulting from overall section-wide EBM analyses may be compared. Alternatively, or additionally, an EBM analysis may be run and deployed using the data from the entire “pre-chorus” and ending at varying durations past the onset of the chorus. The average pitch value for each “section” may be calculated to provide the register changes in successive sections across chorus onsets in successive sections across chorus onsets.

The system 400 of FIG. 4 records the pitch number of every onset in the melodic channel in the section, then takes their arithmetic mean. For example, as seen in Equation 20, ‘M3’ is the third melodic feature, ‘s’ is the section index, ‘N’ is the number of onsets in the melodic channel of the specified section, and ‘Pn’ is the pitch value at onset ‘n’.

$$M {3}_{s} = \frac{1}{N} {\sum }_{n} {P}_{n} \qquad Equation 20$$

The standard deviation of pitch values for each “section” may be computed to provide the changes in range across the change in successive sections. The system 400 of FIG. 4 records the pitch number of every onset in the melodic channel in the section, then takes their standard deviation. For example, as seen on Equation 21, ‘M4’ is the 4th melodic feature, ‘s’ is the section index, ‘N’ is the number of onsets in the melodic channel of the specified section, ‘Pn’ is the pitch value at onset ‘n’, and ‘P’ with a bar is the average pitch value of the onsets in the specified section.

$$M {4}_{s} = \sqrt{\frac{1}{N - 1} {\sum }_{n} \{ {P}_{n} - \underline{P} \}} \qquad Equation 21$$

Melodic expectation may also be calculated more explicitly. Margulis calculates melodic expectation by basing it on a pitch model akin to those of Chew and Krumhansl—e.g., if the last note was a C, then notes like E or G are more expected next than notes like C# because C, E, and G are relatively close in the model. Another consideration in analyzing melodic expectation includes using the various principles outlined by Narmour, et al and, more importantly, the principles outlined by those who have refuted Narmour through behavioral and cognitive experiments.

Other track level features 436 may also be utilized. As would be understood to those possessing an ordinary skill in the art, other features 436 of music may also be used and that the exemplary features provided herein are exemplary. Other features in music may be utilized to calculate an expectation in the music and compare with previously received expectation values based on the preference of the earlier expectation values.

Lyrics 418 or lyrical expression provides a contribution towards the modeling of preference. Differences in the calculated expectation of the lyrics 418 may account for a significant amount of variance in preference measures including “chart position” or “streaming data” or “behavioral data”. Four different general but quantifiable aspects of lyrical expectation information have been shown to be correlated to preference. These include syntactic expectation, semantic expectation, rhyming information and emotional valence of words and phrases.

In syntactic expectation, expectation violations according to the syntax of natural and artificial languages have been shown to reliably evoke specific event related potentials in the brain, and neuroaesthetic and creativity research alike have attributed such neural activity to the type of pleasure response that leads to preference. Of course, such expectation violations must be within constraints in order to achieve the desired effect.

In semantic expectation, violations are based on the juxtaposition of words that do not commonly “make sense” in the context of the words around them, rather than relying on the breaking of rules and established statistical regularities in language. The words may fit syntactically, but present an absurd concept to the listener.

In rhyming information, the rhyme is a device used in poetry and piece of music, in part to enhance aesthetic. Rhyme has the effect of reducing a listener's cognitive load, since it serves to constrain the possible words that can fit in a certain part of a poem or piece of music lyric. By way of example, at least in hip hop, artists who construct pieces of music with more complex rhyme schemes tend to sell more records.

For emotional valence, a primary objective of music (and more specifically, lyrics within pieces of music) is to convey emotion. By measuring the emotional valence of words over time in a piece of music's lyrics, and comparing these valences to the commonly perceived valence of other features during corresponding points in the piece of music, it is possible to quantify expectation violations that lead to outcomes of music preference.

The process of input of lyrics information, both for the overall corpus and for each individual piece of music, is a bit different than the input process for the other six elements. This information comes from the input lyrics 408. This may include a database that has reliable lyric information, linked to timepoints within each piece of music, the scrubbing of information from online sources of lyric information, or from automatic speech-to-text software.

Lyrics are analyzed on both a semantic and a syntactic level. For each word in the lyrics in the pieces of music in our dataset, the words which tend to appear nearby are found, creating a word-word co-occurrence matrix. Linear substructures are then calculated from this database, and these substructures indicate how similar any two words are based on their values in the co-occurrence matrix.

Once the lyrics are analyzed in this way, statistics for each word can be calculated. For instance, note how many syllables and letters each word has. Also, note that an emotional content of each word can be rated, given scholarly lists of emotions associated with dictionaries of words, such as by identifying words indicating happiness, sadness, anger, and so on. Once that is done, statistics for the lyrics in a given piece of music (and sections within that piece of music, such as the chorus) can be calculated.

When all the features are calculated, the system 400 of FIG. 4 can start classifying the calculated features in a classifier 470. Currently the algorithm runs an independent classification in the classifier 470 for each stem feature of each piece of music. Classifier 470 operates with a K-Means classifier; for a given stem feature in a given piece of music, the 1017 values of that feature (one for each window) are put into the classifier, and the system identifies creates 2-12 classes and identifies the value in each window as belonging to one of the classes. Additionally, for each number of classes, two classifications are performed: one where the classifiers are sorted in terms of average value of the class (i.e., windows which belong to class ‘1’ have smaller values, on average, than those that belong to class ‘2’, etc.) and one where the classifiers are sorted in terms of the number of elements in each class (i.e., windows which belong to class ‘1’ have fewer values than those that belong to class ‘2’, etc.).

Data output 492 may be provided in a number of forms. The purpose of the data output 492 is to provide information to a user regarding the input piece of music. This information may include the underlying value in the piece of music as calculated by the features and set using comparisons to preferential or other feature data. Further, outputs may include the piece of music, respective tracks of the piece of music, lyrics, and other data included within system 10. Further, the data output 492 may include the weighting used in classifier 470 in combining the various features and comparing across other known pieces of music in the database. Additionally, the data output 492 may conclude a comparison piece of music or pieces of music that the presently analyzed piece of music most closely approximates, either musically, financially, or preferentially, based on the analysis and comparison included in the system 400.

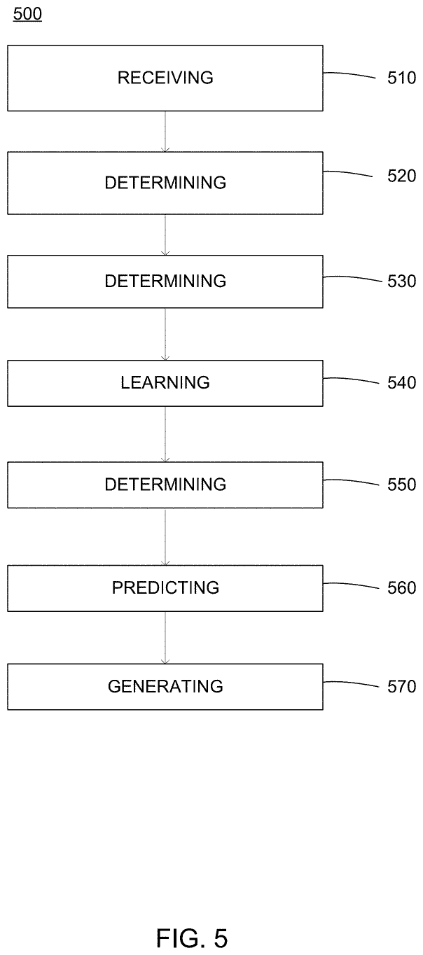

Turning now to FIG. 5, a method 500, in conjunction with the computing system 100 of FIG. 1, is shown for computing orders of modeled expectation across features of music within a corpus of music. Method 500 includes, at block 510, the determination engine 101 receiving a media dataset. The media dataset 110 comprising target piece music information 111 (e.g., a selected piece of music), target piece audience information 112, corpus music information 113, corpus audience information 114, and corpus preference data 115. According to one or more embodiments, the determination engine 101 can split the selected piece of music into tracks to provide split tracks.

At block 520, the determination engine 101 determines a subset of the corpus music and preference information (e.g., 113, 115) utilizing a similarity of the target piece audience information 112 and the corpus audience information 114. At block 530, the determination engine 101 determines at least one surprise factor of the subset of the corpus music and preference information (e.g., 113, 115) across a plurality of features 120 at one of a plurality of orders. Note that the at least one surprise factor can include a modeled expectation violation calculation and that a number of orders of the plurality of orders can be an integer greater than one. Further, as described herein, the at least one surprise factor can be harmony, melody, rhythm, timbre, texture, dynamics, or lyrics.

At block 540, the determination engine 101 learns, within the subset of the corpus music and preference information (e.g., 113, 115), a model that estimates a likelihood that one or more time-varying surprise trends across the plurality of features 120 achieves a preference level. At block 550, the determination engine 101 determines at least one surprise factor of the target piece music information 111 across the plurality of features 120 at the one of the plurality of orders. At block 560, the determination engine 101 predicts, using the model, preference information using the one or more time-varying surprise trends for the target piece music information 111 across the plurality of features 120. In addition, at block 570, the determination engine 101 generates a recommendation output comprising user output information indicating the preference information according to expectations of a given intended audience. Note that the given intended audience can be based on a geographic region. According to one or more embodiments, int the context of the process flow 500, the determination engine 101 can further acquire lyrics of the target piece music information 111, execute a lyric analysis based on the lyrics of the target piece music information 111 to provide lyric results, and generate a recommendation output corresponding to the target piece music information 111 using the media dataset and the lyric results.

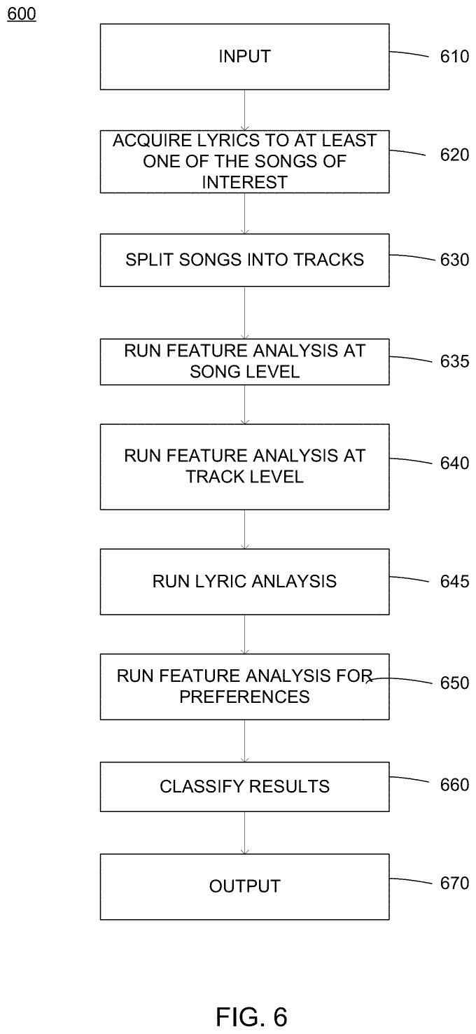

FIG. 6 illustrates a method 600, in conjunction with the system 400 of FIG. 4, for computing (several) orders of modeled expectation across (several) features of music within a corpus of music. Method 600 includes inputting a piece of music, series of pieces of music, preferential data and audience-based data into the system 400 at block 610. At block 620, the system 400 acquires the lyrics 418 to at least of the pieces of music of interest. At block 630, a splitter 416 splits the piece of music(s) into tracks. At block 635, the system 400 runs a feature analysis at the piece of music level to examine key, duration and temp, for example. At block 640, the system runs a feature analysis using the split tracks from the splitter 416 at the track level to examine timbre, harmony, rhythm, texture, dynamics, melody, for example. At block 645, the system 400 performs lyric analysis based on the input lyrics. At block 650, the system 400 runs preference analysis using the input piece of music, series of pieces of music, preferential data and audience-based data to perform repetition, preference analysis, quartile analysis, artist analysis, genre and visualization, for example. At block 660, classifier 470 classifies the analyses (that are run in method 600) and provides an output (at block 670), as described herein.

Hybrid MIR/MIDI analyses may also be performed. By doing so, the system 400 may use the strengths of each approach to fortify the other. For example, MIR is good for getting ground-truth approximate measurements of events in a recording. The MIDI transcriptions are good for identifying discrete elements within a piece of music, labeled for pitch and onset, and clearly separated into tracks. Currently, the MIDI data is used as described herein. The system 400 may also learn to use the MIR methods to gain the information that is currently resulting from the MIDI analysis. At that point, the MIR methods provide the information needed for the analyses without MIDI.

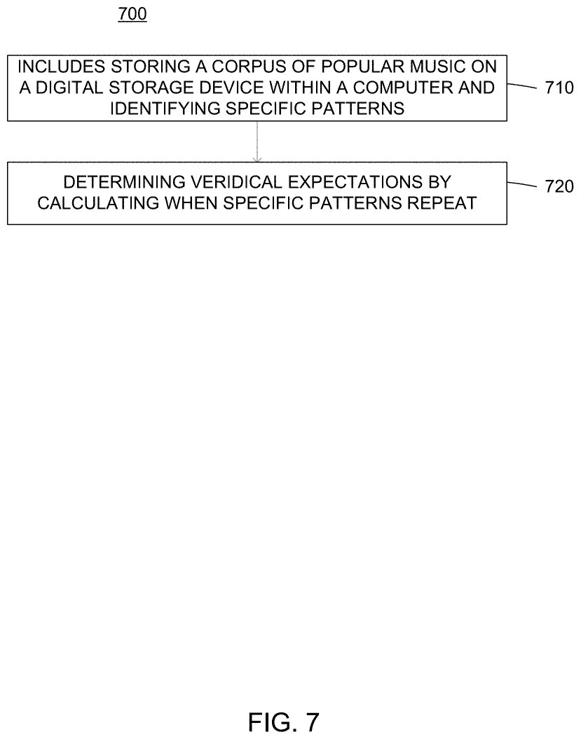

FIG. 7 illustrates a method 700 for determining repetition (element 42 of FIG. 4) in a corpus of music according to one or more embodiments. The method 700 can be executed by a determination engine, as described herein, as a multi-step process. At block 710, the determination engine stores a corpus of popular music on a digital storage device within a computer and identifies specific patterns. The identifying specific patterns (of block 710) may include smoothing out minor differences. The identifying specific patterns (of block 710) may also include extracting a feature from point to point in a piece of music and analyzing the feature with a self-similarity matrix to find instances of specific patterns repeating. The identifying specific patterns (of block 710) may include identifying specific patterns within one piece of music. The identifying specific patterns (of block 710) may include identifying specific patterns across at least two pieces of music. At block 720, the determination engine determines veridical expectations by calculating when specific patterns repeat.

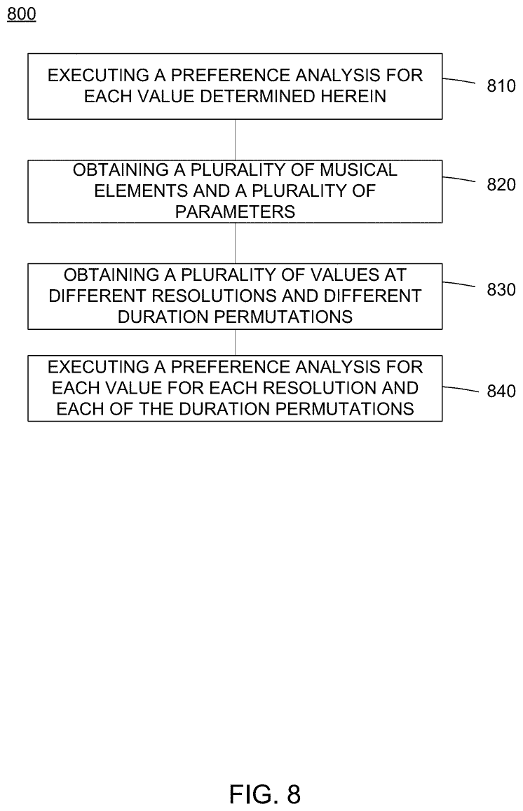

FIG. 8 illustrates a method 800 for executing preference analysis according to one or more embodiments. The method 800 can be executed by a determination engine, as described herein, as a multi-step process. At block 810, the determination engine executes a preference analysis for each value determined herein. At block 820, the determination engine obtains a plurality of musical elements and a plurality of parameters. At block 830, the determination engine obtains a plurality of values at different resolutions and different duration permutations. At block 840, the determination engine executes a preference analysis for each value for each resolution and each of the duration permutations.

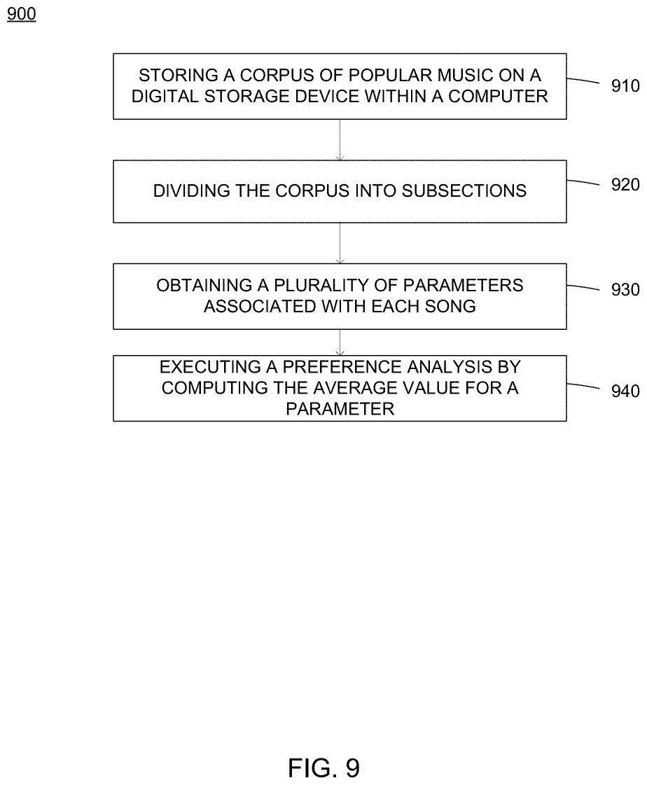

FIG. 9 illustrates a method 900 for executing a quartile analysis according to one or more embodiments. The method 900 can be executed by a determination engine, as described herein, as a multi-step process. At block 910, the determination engine stores a corpus of popular music (e.g., including charting information pieces of music) on a digital storage device within a computer at step 510. At block 920, the determination engine divides the corpus into subsections. The dividing step (at block 920) may include dividing the corpus into quartiles. The quartiles can be chosen by identifying peak charting information positions for all pieces of music within the corpus, and then identifying the peak chart position in the top quartile and the bottom quartile. At block 930, the determination engine obtains a plurality of parameters associated with each piece of music (e.g., based on blocks 910 and 920). At block 940, the determination engine executes a preference analysis by computing the average value for a parameter. Performing a preference analysis (at block 940) can include performing a preference analysis by computing the average value for a parameter across all pieces of music that have the range of peak charting information positions identified for each quartile.

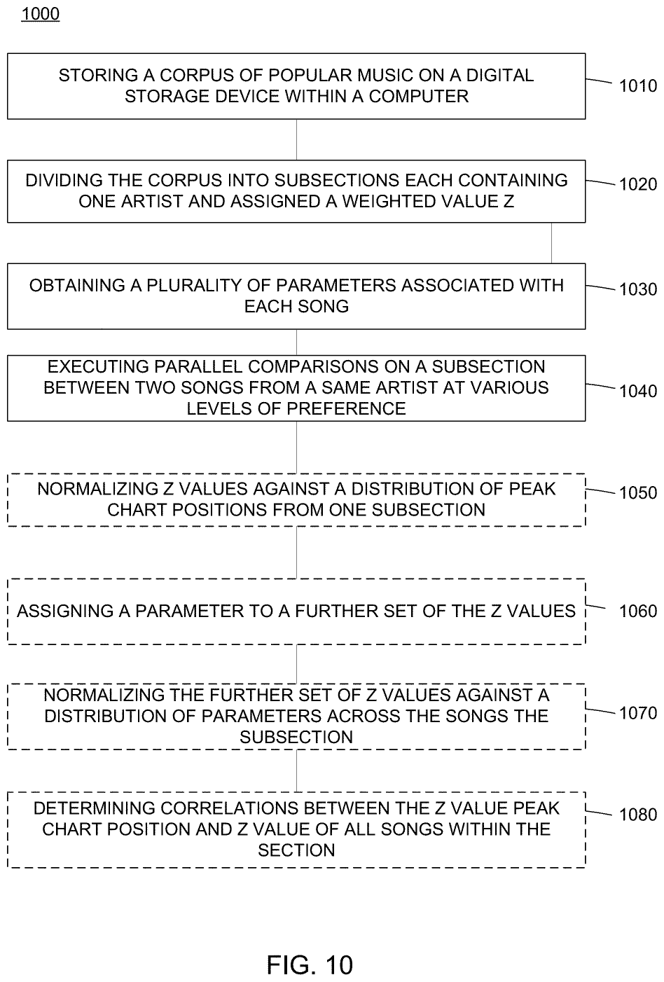

FIG. 10 illustrates a method 1000 for executing a within-artist analysis according to one or more embodiments. The method 1000 can be executed by a determination engine, as described herein, as a multi-step process. At block 1010, the determination engine stores a corpus of popular music (e.g., including charting information pieces of music) on a digital storage device within a computer. At block 1020, the determination engine divides the corpus into subsections each containing one artist and assigned a weighted value Z. At block 1030, the determination engine obtains a plurality of parameters associated with each piece of music (e.g., based on blocks 1010 and 1020). At block 1040, the determination engine executes parallel comparisons on a subsection between two pieces of music from the same artist at various levels of preference. At block 1050, the determination engine can normalize the Z values against the distribution of peak chart positions from one subsection. At block 1060, the determination engine can assign a parameter to a further set of Z values. At block 1070, the determination engine can normalize the further set of Z values against the distribution of parameters across the pieces of music in the subsection. At block 1080, the determination engine can determine correlations between the Z value peak chart position and Z value of all pieces of music within the section.

A reliable database may be created or accessed to categorize the genres of all the pieces of music in the analysis. This categorization may allow for further analyses using isolated segments of the corpus to identify effects that are exhibited more strongly across some genres than others. The features for the entire piece of music may be determined as described above. The entire piece of music features may include key, duration and tempo.

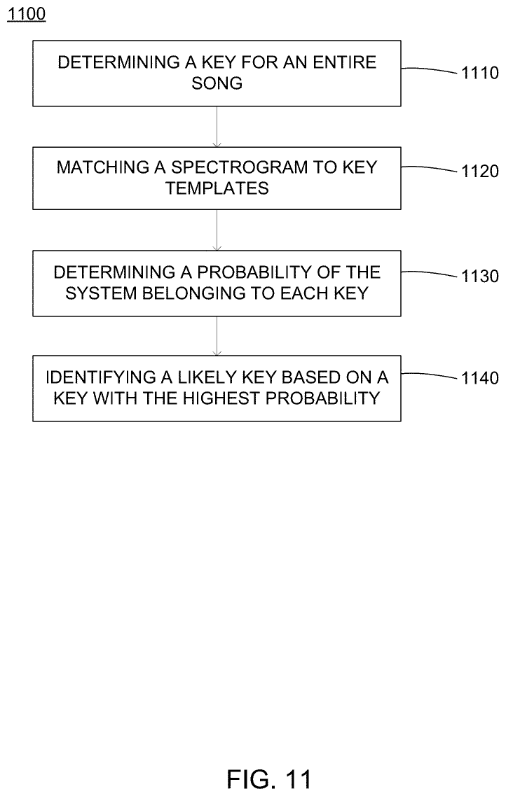

FIG. 11 illustrates a method 1100 for determining the key for a corpus of music according to one or more embodiments. The method 1100 can be executed by a determination engine, as described herein, as a multi-step process. At block 1110, the determination engine determines (e.g., estimates or calculates) a key for an entire piece of music. The estimated key can be calculated using a neural network, such as a Convolutional Neural Network (CNN) based key detection algorithm included in a madmom Python package. The CNN based key detection algorithm features a 5-layer CNN that is trained on 20-second spectrograms of thousands of pieces of music from multiple genres, including dance, pop, and classical. This calculation obtains templates for each key that are not limited to one single genre but instead work across many genres. The CNN model may be genre-agnostic. A CNN based system, as implemented in the madmom Python package, may provide the probability of each key along with the key itself, and that probability can be used as an indicator of confidence. Alternatively, the estimating of the key may include using the helix model devised by Elaine Chew.

In general, a neural network is a network or circuit of neurons, or in a modern sense, an artificial neural network (ANN), composed of artificial neurons or nodes or cells. For example, an ANN involves a network of processing elements (artificial neurons) which can exhibit complex global behavior, determined by the connections between the processing elements and element parameters. These connections of the network or circuit of neurons are modeled as weights. A positive weight reflects an excitatory connection, while negative values mean inhibitory connections. Inputs are modified by a weight and summed using a linear combination. An activation function may control the amplitude of the output. For example, an acceptable range of output can be between 0 and 1. Alternatively, an acceptable range of output can be −1 and 1. In most cases, the ANN is an adaptive system that changes its structure based on external or internal information that flows through the network. In more practical terms, neural networks are non-linear statistical data modeling or decision-making tools that can be used to model complex relationships between inputs and outputs or to find patterns in data. Thus, ANNs may be used for predictive modeling and adaptive control applications, while being trained via a dataset. Note that self-learning resulting from experience can occur within ANNs, which can derive conclusions from a complex and seemingly unrelated set of information. The utility of artificial neural network models lies in the fact that they can be used to infer a function from observations and also to use it. Unsupervised neural networks can also be used to learn representations of the input that capture the salient characteristics of the input distribution, and more recently, deep learning algorithms, which can implicitly learn the distribution function of the observed data. Learning in neural networks is particularly useful in applications where the complexity of the data or task makes the design of such functions by hand impractical.

Neural networks can be used in different fields. The tasks to which ANNs are applied tend to fall within the following broad categories: function approximation, or regression analysis, including time series prediction and modeling; classification, including pattern and sequence recognition, novelty detection and sequential decision making, data processing, including filtering, clustering, blind signal separation and compression. Application areas of ANNs include nonlinear system identification and control (vehicle control, process control), game-playing and decision making (backgammon, chess, racing, music selection), pattern recognition (radar systems, face identification, object recognition), sequence recognition (music preference, gesture, speech, handwritten text recognition), medical diagnosis, financial applications, data mining (or knowledge discovery in databases, “KDD”), visualization and e-mail spam filtering. For example, it is possible to create a semantic profile of user's interests emerging from pictures trained for object recognition.

According to one or more exemplary embodiments, the neural network implements a long short-term memory neural network architecture, a CNN architecture, or other the like. The neural network can be configurable with respect to a number of layers, a number of connections (e.g., encoder/decoder connections), a regularization technique (e.g., dropout); and an optimization feature. The long short-term memory neural network architecture includes feedback connections and can process single data points (e.g., such as images), along with entire sequences of data (e.g., such as speech or video). A unit of the long short-term memory neural network architecture can be composed of a cell, an input gate, an output gate, and a forget gate, where the cell remembers values over arbitrary time intervals and the gates regulate a flow of information into and out of the cell. The CNN architecture is a special type of ANN that contains one or more convolutional layers. The regularization technique of an ANN architecture can take advantage of the hierarchical pattern in data and assemble more complex patterns using smaller and simpler patterns by preventing overfitting. If the neural network implements the CNN architecture, other configurable aspects of the architecture can include a number of filters at each stage, kernel size, a number of kernels per layer.

At block 1120, the determination engine determines a spectrogram to key templates. The piece of music's spectrogram is calculated and passed into the CNN, which attempts to match that spectrogram to each of the 24 key templates (e.g., 12 major and 12 minor, with only 1 template used for enharmonic pairs). At block 1130, the determination engine determines a probability of a system belonging to each key. At block 1140, the determination engine identifies a likely key based on a key with the highest probability. For more details on the algorithm, see the paper “Genre Agnostic Key Classification with Convolutional Neural Networks” by Filip Korzeniowski and Gerhard Widmer, incorporated by reference as if set forth in its entirety.

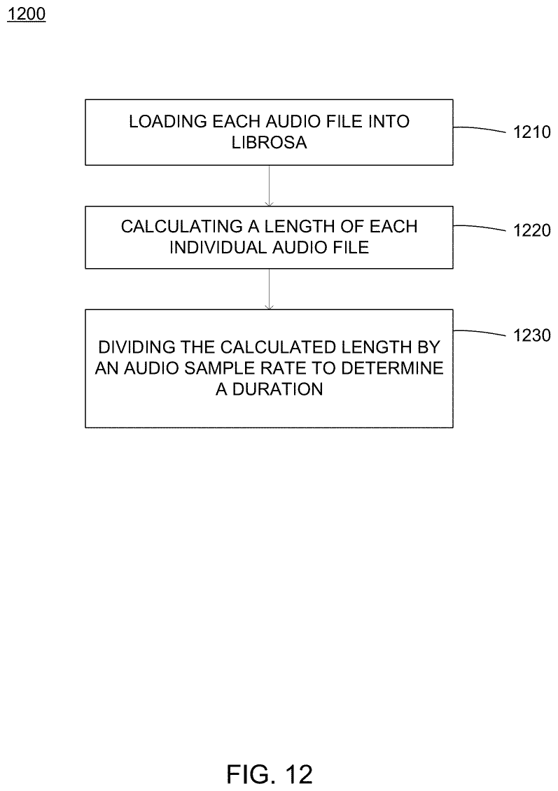

FIG. 12 illustrates a method 1200 for determining the duration in a corpus of music according to one or more embodiments. The method 1200, generally, describes operations of a determination engine. At block 1210, the determination engine loads each audio file into a LibRosa toolbox. At block 1220, the determination engine determines the length of each individual audio file. At block 1220, the determination engine divides the calculated length by an audio sample rate to determine a duration.

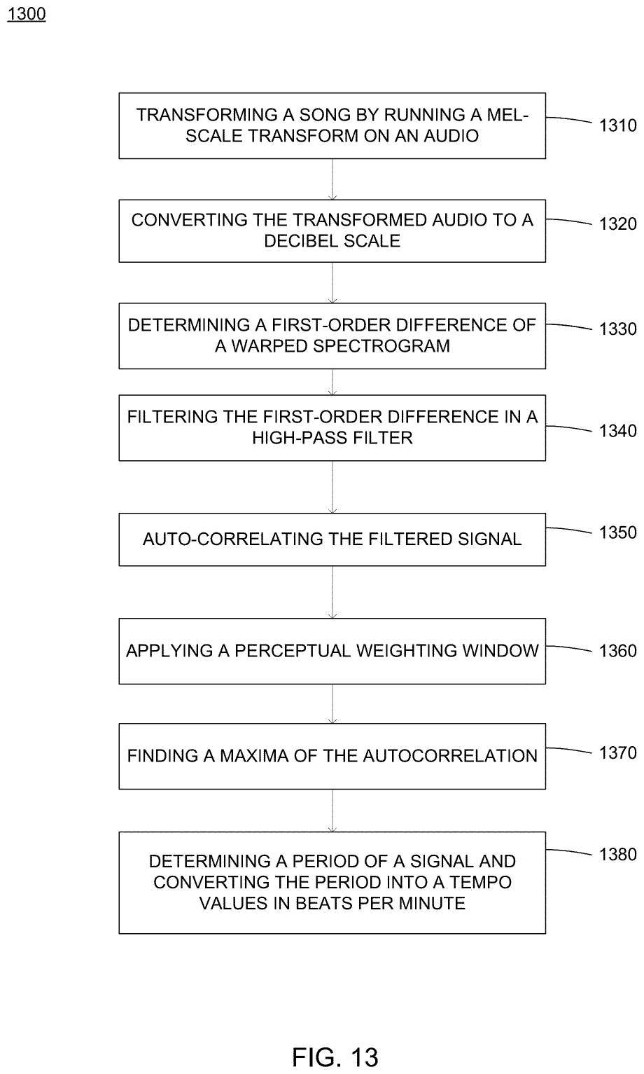

FIG. 13 illustrates a method 1300 for determining tempo of a corpus of music according to one or more embodiments. The method 1300 can be executed by the determination engine 101, as described herein, as a multi-step process to calculate tempo using the dynamic programming approach (Ellis et al. 2007). The notion is that, for a given audio signal, the system first calculates an onset signal, defined as a signal which can be expected to have large values at beat positions. A global tempo is then calculated by looking at the onset signal's periodicity.

The method 1300 begins at block 1310, where the determination engine transforms a piece of music by running the Mel-scale transform on an audio. At block 1320, the determination engine converts the transformed audio to a decibel scale to enable a computer to perceive beats similarly to humans, with periodicity and dynamics considered.

At block 1330, the determination engine determines first-order difference of the warped spectrogram to highlight frames with drumbeats and other beats as these frames are likely to have large positive differences relative to their preceding frames. At block 1340, the determination engine filters the first-order difference in a high-pass filter to produce a filtered signal (e.g., a cutoff frequency at 0.4 Hz). At block 1350, the determination engine auto-correlates the filtered signal. At block 1360, the determination engine applies a perceptual weighting window. Auto-correlations have large values (e.g., a value above 0.9, where 1.0 is a maximum value) when a lag in the auto-correlation is a match or a multiple of the periodicity of the signal being auto-correlated. The perceptual weighting window emphasizes common tempos (e.g., near 120 BPM, the most common tempo in music) to further increase the chances of the system's output matching what a human would perceive. At block 1370, the determination engine finding a maxima of the auto-correlation. At block 1380, the determination engine determines a period of the filtered signal and converting the period into a tempo values in beats per minute (see Ellis et al. 2007). Audio features for individual windows and stems may also be calculated.

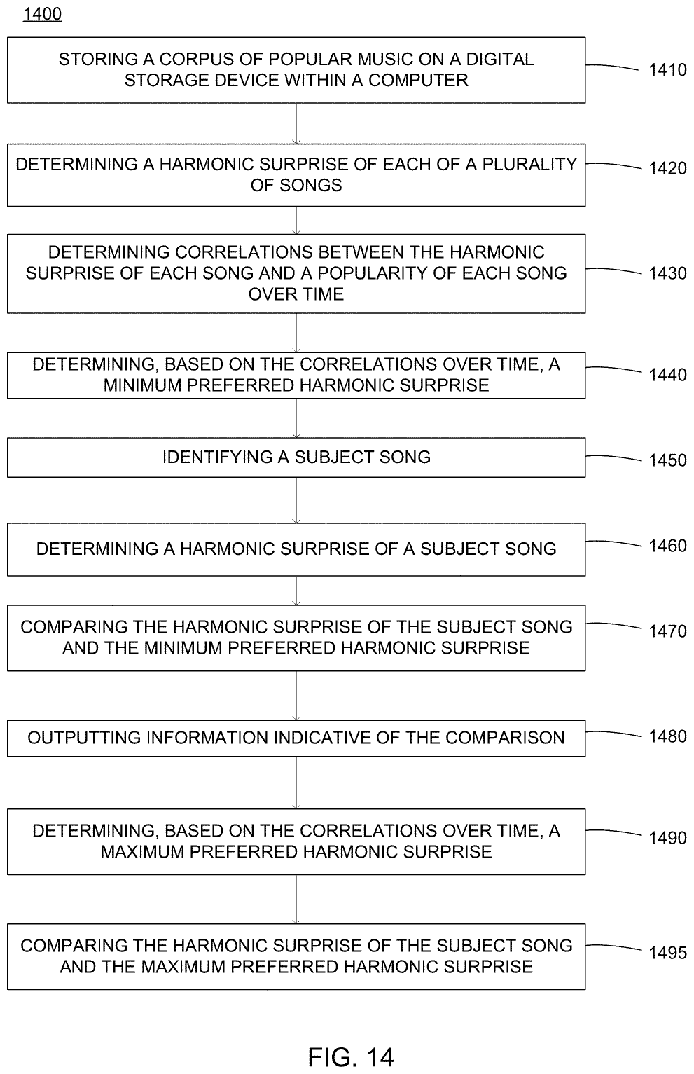

FIG. 14 illustrates a method 1400 for determining harmony in a corpus of music according to one or more embodiments. The method 1500 can be executed by a determination engine, as described herein, as a multi-step process to calculate harmonic surprise. Each stem file is converted into MIDI unless MIDI of the audio file already exists. The conversion may be performed by importing the stem audio into Melodyne and then exporting it as a MIDI file. The chords for all the stem files are gathered together, and the number of occurrences of each chord is recorded. The ‘prevalence’ value of each chord is calculated as the number of occurrences of the chord divided by the number of occurrences of all chords (e.g., if a C-Major/5 chord occurred ten times in a set of 100 chords, the C-Major/5 chord would have a prevalence value of 0.1). The ‘surprise’ value of each chord is then calculated as—log 2(prevalence of that chord). In any given window, the surprise values of the chords in that window are averaged, and that average surprise value is the harmonic surprise value for that window. For more information on this feature, see “A Statistical Analysis of the Relationship Between Harmonic Surprise and Preference in Popular Music.” The chord positions in the MIDI file may be given in terms of absolute time, but the windows may be relative. In such an embodiment, the chords may be aligned to the relative windows. In each window, the harmonic surprise is calculated for the other and piano stems.

The method 1400, generally, describes operations by the determination engine for evaluating popular music based on harmonic surprise within a corpus of popular music. The harmonic surprise may include one or both of absolute harmonic surprise and contrastive harmonic surprise. At block 1410, the determination engine stores a corpus of popular music on a digital storage device within a computer. The corpus includes a plurality of pieces of music, their sections and their corresponding MIDI files. At block 1420, the determination engine determines the harmonic surprise of each of the plurality of pieces of music. At block 1416, the determination engine determines correlations between the harmonic surprise of each piece of music and the popularity of each piece of music over time. At block 1440, the determination engine determines based on the correlations over time a minimum preferred harmonic surprise, as determined by surprise measures of highly preferred pieces of music in the corpus. At block 1450, the determination engine identifies a subject piece of music. At block 1460, the determination engine determines the harmonic surprise of the subject piece of music. At block 1470, the determination engine compares the harmonic surprise of the subject piece of music and the minimum preferred harmonic surprise. Note that identifying the subject piece of music (at block 1450) and comparing the harmonic surprise of the subject piece of music (at block 1470) may include generating the subject piece of music, based on the corpus, with the minimum preferred harmonic surprise. At block 1480, the determination engine outputs information indicative of the comparison. At block 1490, the determination engine determines based on the correlations over time a maximum preferred harmonic surprise. At block 1495, the determination engine compares the harmonic surprise of the subject piece of music and the maximum preferred harmonic surprise.

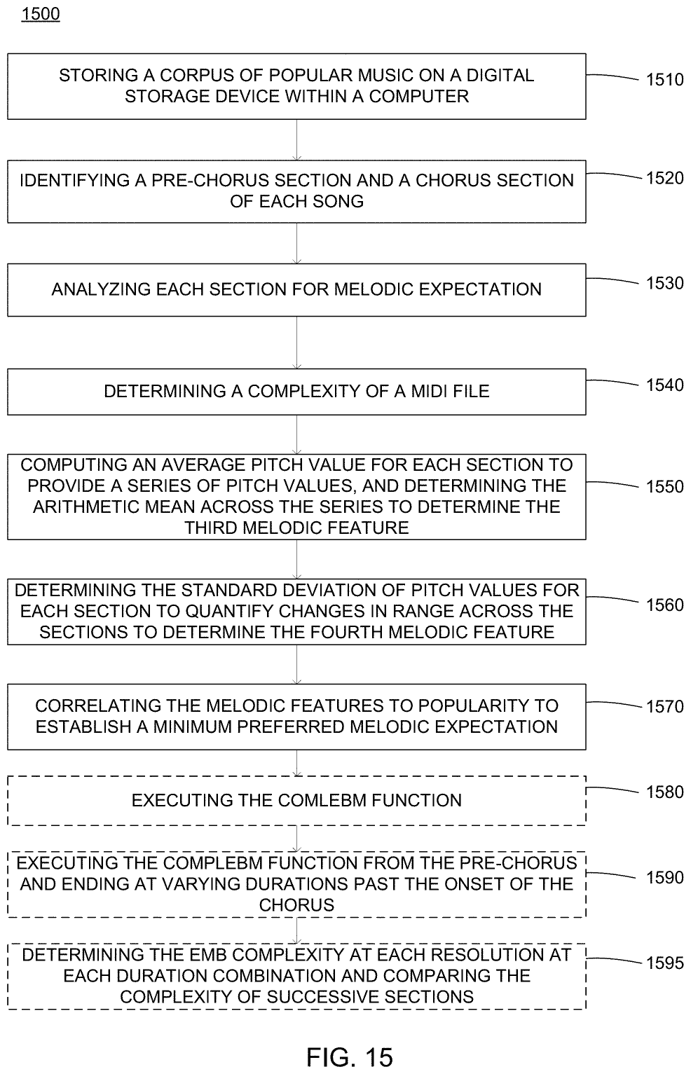

FIG. 15 illustrates a method 1500 for determining melody in a corpus of music. The method 1500 can be executed by a determination engine, as described herein, as a multi-step process to calculate melody. The audio is passed into the MELODIA vamp plug-in. This plug-in estimates the fundamental frequency of the melody of the music by identifying the spectral peaks in a piece of audio and then crafting ‘pitch contours’, i.e., sets of spectral peaks which are continuous in time and frequency, from those spectral peaks. Once the pitch contours are created, the (several) features are extracted from each contour. Heuristics are used on the features to identify the contour whose features indicate it is most likely to be the melody. For more information on this method see “Melody Extraction from Polyphonic Music Signals Using Pitch Contour Characteristics” by Justin Salamon and Emilia Gomez, incorporated by reference as if set forth in its entirety.

Once the melody frequencies are known, the melody frequencies pitch class is identified by mapping the melody frequency of each window to the center of the nearest pitch class. For instance, if the algorithm determined that the likely melody frequency for a given window was 439 Hz, the closest pitch class may be defined to be the ‘A’ centered at 440 Hz. The closest pitch allows for a determination that the melody for the window in question is likely an ‘A.’ The number of half-step shifts needed to transition from the key of the music to the key of the window is then calculated. For instance, if a piece of music in the key of F Major were found to have a certain window whose melody frequency was ‘A,’ 4 half steps are required to get from F to A. This number of half steps is reported as the melody feature.

In each window, the melody feature is calculated for the bass and vocal stems.

According to one or more embodiments of the method 1500, the determination engine evaluates melodic expectation within a corpus of popular music. At block 1510, the determination engine stores a corpus of popular music on a digital storage device within a computer. The corpus includes a plurality of pieces of music, their sections and their corresponding MIDI files. At block 1520, the determination engine identifies the pre-chorus section and the chorus section of each piece of music. At block 1530, the determination engine analyzes each section for melodic expectation. At block 1540, the determination engine identifies a complexity of a MIDI file. At block 1550, the determination engine determines an average pitch value for each section to provide a series of pitch values, and then determines/calculates the arithmetic mean across the series to determine the third melodic feature. At block 1560, the determination engine determines a standard deviation of pitch values for each section to quantify changes in range across the sections to determine the fourth melodic feature. At block 1570, the determination engine correlates melodic features to popularity to establish a minimum preferred melodic expectation.

At block 1580, the determination engine can execute the complebm function in the MATLAB MIDI toolbox. At block 1590, the determination engine can execute the complebm function in the MATLAB MIDI toolbox from the pre-chorus and ending at varying durations past the onset of the chorus. At block 1595, the determination engine can determine the complexity at each resolution at each duration combination and compare the complexity of successive sections. Note that the dashed-borders of block 1580, 1590, and 1595 indicate that these are optional operations for the method 1500.

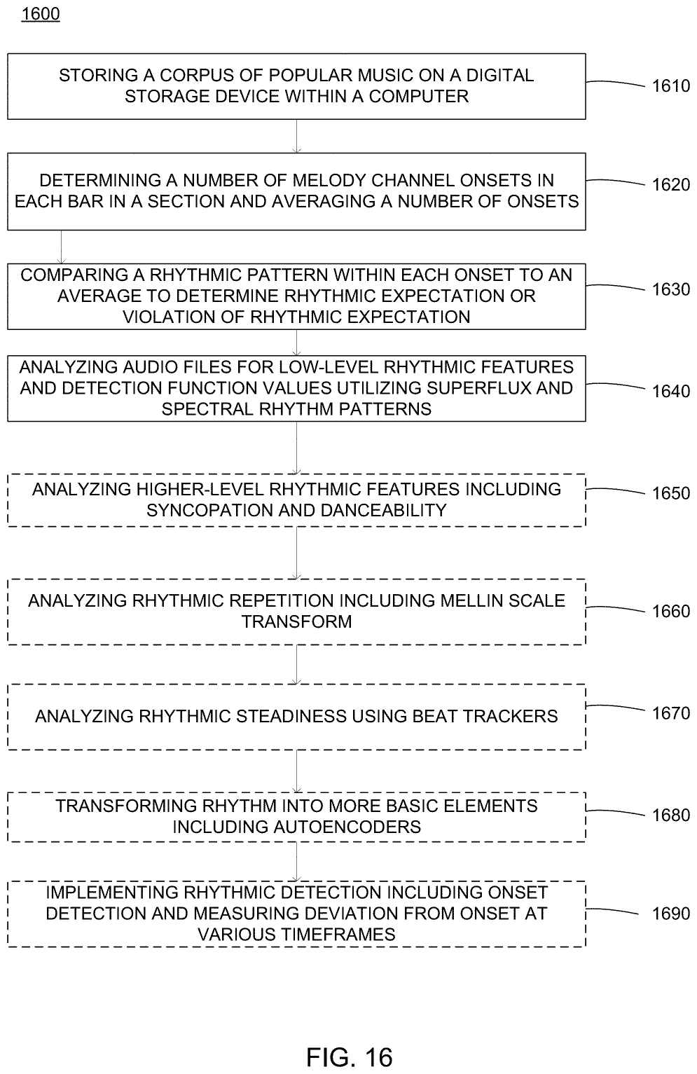

FIG. 16 illustrates a method 1600 for determining rhythm in a corpus of music. Rhythm is an indication of the pattern that the music forms in time. There are three measures of rhythm including perceptual superflux, harmonic/percussive source separation (HPSS)-based onset detection, and tempo.

Perceptual superflux is an onset function which is designed to have large values in windows that contain beats and smaller values elsewhere. Perceptual superflux is based on the spectral flux, which is calculated by taking the magnitude spectrogram of a signal, calculating the first-order difference of each frequency in that spectrogram over time, and then summing all positive values of the difference. Spectral flux is thus large when the magnitude spectrogram in one frame is larger than in the previous frame. However, spectral flux has trouble dealing with music that contains vibrato, since vibrato makes some frequencies change values rapidly despite the absence of beats, and thus results in large spectral flux values that are not actually indicative of beat locations. Superflux changes the spectral flux calculation by passing the spectrogram through a maximum filter (e.g., a filter that depends entirely on an input signal) in which each cell of the spectrogram is set equal to the maximum of its own value, the value at the same time index but one frequency index up, and the value at the same time index but one frequency value down. This smooths out the vibrato and results in a more accurate onset signal. In this implementation, the spectrogram is first warped to the Mel-scale before superflux is calculated, so the onset signal more closely matches human perception of the rhythm. For more information on superflux, see “Maximum Filter Vibrato Suppression for Onset Detection” by Sebastian Bock and Gerhard Widmer, incorporated by reference as if set forth in its entirety.

HPSS-based onset detection: First, the spectrogram is decomposed into harmonic (i.e., horizontal) components and percussive (i.e., vertical) components, with focus on the percussive components. This decomposition may be performed with a median filtering step. Median filtering is an algorithm where values in a window are replaced by the median values of the surrounding windows. By performing median filtering for each instant in time over (several) frequency bands, elements that are consistent across frequencies in the window (such as drumbeats which span a wide range of the spectrum) are retained, but elements which are much stronger in one or two frequency bands than the others (such as harmonic notes which are strong in just the fundamental frequency and harmonics) are replaced by a likely small median value of the cell around them. In this way the harmonic components are erased and the percussive components are retained. A similar filtering step, filtering over one frequency band across multiple neighboring time instances, is done to create a harmonic mask. The percussive mask is then further de-noised by finding the ratio of the percussive component to the harmonic component at each moment in time and each frequency band, and removing any element of the percussive component where that ratio is smaller than a certain threshold. The percussive mask eliminates cells which may be marginally percussive but still have enough harmonic energy that the cell likely isn't entirely percussive. The original signal is then masked by the percussive mask to retain just the percussive elements of the music. Once that is done, superflux is calculated on just the percussive component. For more information on the HPSS process, see “Harmonic/Percussive Source Separation Using Median Filtering” by Derry FitzGerald (for the median filtering technique), and “Extending Harmonic-Percussive Separation of Audio Signals” by Jonathan Driedger et. al. (for the de-noising-via-ratio step), incorporated by reference as if set forth in its entirety.

Tempo is calculated for each window using the same dynamic programming technique as is used when it's calculated for the whole piece of music.

In each window, the two superflux features are calculated for all five stem files. Tempo is calculated for the mixed audio as a whole.

The method 1600, generally, describes operations by the determination engine for evaluating rhythmic expectation within a corpus of popular music. At block 1610, the determination engine stores a corpus of popular music on a digital storage device within a computer. The corpus includes a plurality of pieces of music, their sections and their corresponding MIDI files. At block 1620, the determination engine determines the number of melody channel onsets in each bar in the section and averaging the number of onsets. At block 1630, the determination engine compares the rhythmic pattern within each onset to the average to determine rhythmic expectation or violation of rhythmic expectation. At block 1640, the determination engine can analyze analyzing audio files for low-level rhythmic features and detection function values utilizing superflux and spectral rhythm patterns. At block 1650, the determination engine can analyze higher-level rhythmic features including syncopation and dance-ability. At block 1660, the determination engine can analyze rhythmic repetition including a Mel-scale transform. At block 1670, the determination engine can analyze rhythmic steadiness using beat trackers. At block 1680, the determination engine can transform rhythm into more basic elements including auto-encoders. At block 1690, the determination engine implement analyze rhythm detection including onset detection and measuring deviation from onset at various timeframes. Note that the dashed-borders of block 1650, 1660, 1670, 1680, and 1690 indicate that these are optional operations for the method 1600.

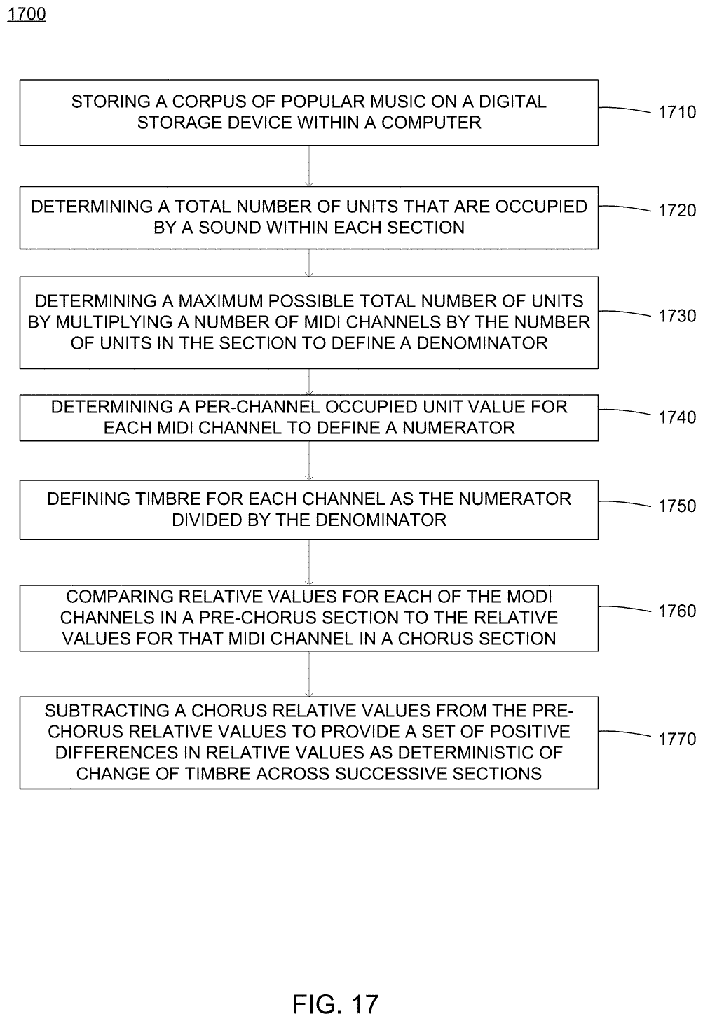

FIG. 17 illustrates a method 1700 for determining timbre in a corpus of music (e.g., within the pieces of music therein) according to one or more embodiments. The method 1700 can be executed by a determination engine, as described herein. Timbre measures the quality, or the characteristics, of a musical sound, irrespective of pitch and volume. Timbre may be measured by calculating features which have empirically been found to affect how people perceive a sound's timbre. This research is detailed in the paper “Timbral Features Contributing to Perceived Auditory and Musical Tension,” by Morwaread Farbood and Khen Price, and the present implementations utilize the timbre aspects of the LibRosa and the AudioCommons Python packages, each of which is incorporated by reference herein as if set forth in their entirety.

The features of timbre include roughness, spectral centroid, spectral flatness and spectral spread.

Roughness is a feature that measures whether pairs of sinusoids are close enough to cause the listener to hear a ‘beating’ sensation. Roughness is found by identifying all the peaks in the spectrogram, finding the dissonance between all possible peak pairs, and then averaging those dissonances. Given any two consecutive peaks, the smaller with a magnitude ‘P1’ and frequency ‘F1’, and the larger with a magnitude ‘P2’ and a frequency ‘F2’, the roughness value of those peaks SR is calculated with Equations 22-26.

$$\begin{matrix}SR = 0.5 * {A}^{0.1} * {Y}^{3.11} * C & Equation 22 \\ A = {P}_{1} * {P}_{2} & Equation 23 \\ B = \frac{2 {P}_{1}}{{P}_{1} + {P}_{2}} & Equation 24 \\ C = {e}^{- 3 .5 G ( {f}_{2} - {f}_{1} )} - {e}^{- 5.75 G ( {f}_{2} - {f}_{1} )} & Equation 25 \\ G = \frac{0.24}{0.0207 {f}_{1} + 18.96} & Equation 26\end{matrix}$$

Spectral centroid is a feature that correlates with how ‘bright’ something sounds. Spectral centroid is equivalent to the center of mass in a spectrum, and is calculated by taking each frequency present in the spectrum of a signal, weighting each frequency by its own magnitude, summing the weighted frequencies, and normalizing. Equation 27 describes a spectral centroid value SC, for a windowed signal x with a spectrogram S that is divided into frequency bins k (each of which corresponds to a frequency fin Hz) and time bins n.

$$S C = \frac{{Σ}_{k } S [ k , n ] * f [ k ]}{{Σ}_{j} S [ j , n ]} \qquad Equation 27$$

Spectral flatness is a feature that correlates with how ‘pitched’ something sounds. Spectral flatness is calculated by taking the geometric mean of a signal's power spectrum and dividing that value by the arithmetic mean of the same power spectrum. A high flatness value indicates that the signal has roughly equal power in all spectral bands and is thus similar to white noise. A low flatness value indicates that some frequencies have more power than others, and that the sound thus has tones. Equation 28 describes a spectral flatness value SF, for a windowed signal x with a spectrogram S that is divided into frequency bins k and time bins n.

$$S F = \frac{\sqrt[K]{{Π}_{k } \vert S [ k ] \vert}}{\frac{{Σ}_{K } \vert S [ k ] \vert}{K}} \qquad Equation 28$$

Spectral spread is a feature that provides an indication of how pitched or noisy a signal is. Spectral spread is calculated by taking the standard deviation of the magnitude spectrum. Equation 29 describes a spectral spread value SP, for a windowed signal x with a spectrogram S that is divided into frequency bins k (each of which corresponds to a frequency fin Hz) and time bins n.

SP=\sqrt{ΣₖS[k]*(f[k]−SC)²}. Equation 29

In each window, all four timbre features are calculated for all stem files.

The method 1700, generally, describes operations by the determination engine for evaluating timbral expectation within a corpus of popular music. At block 1710, the determination engine stores a corpus of popular music on a digital storage device within a computer. The corpus includes a plurality of pieces of music, their sections and their corresponding MIDI files. At block 1720, the determination engine determines the total number of units that are occupied by a sound within each section. At block 1730, the determination engine determines the maximum possible total number of units by multiplying the number of MIDI channels by the number of units in the section to define the denominator. At block 1740, the determination engine determines the per-channel occupied unit value for each MIDI channel to define the numerator. The determination of block 1740 may be repeated for each channel to determine a relative value for each MIDI channel. At block 1750, the determination engine defines timber for each channel as the numerator divided by the denominator. At block 1760, the determination engine compares the relative values for each of the MIDI channels in the pre-chorus section to the relative values for that MIDI channel in the chorus section. At block 1740, the determination engine can subtract the chorus relative values from the pre-chorus relative values to provide a set of positive differences in relative values as deterministic of change in timbre across successive sections.

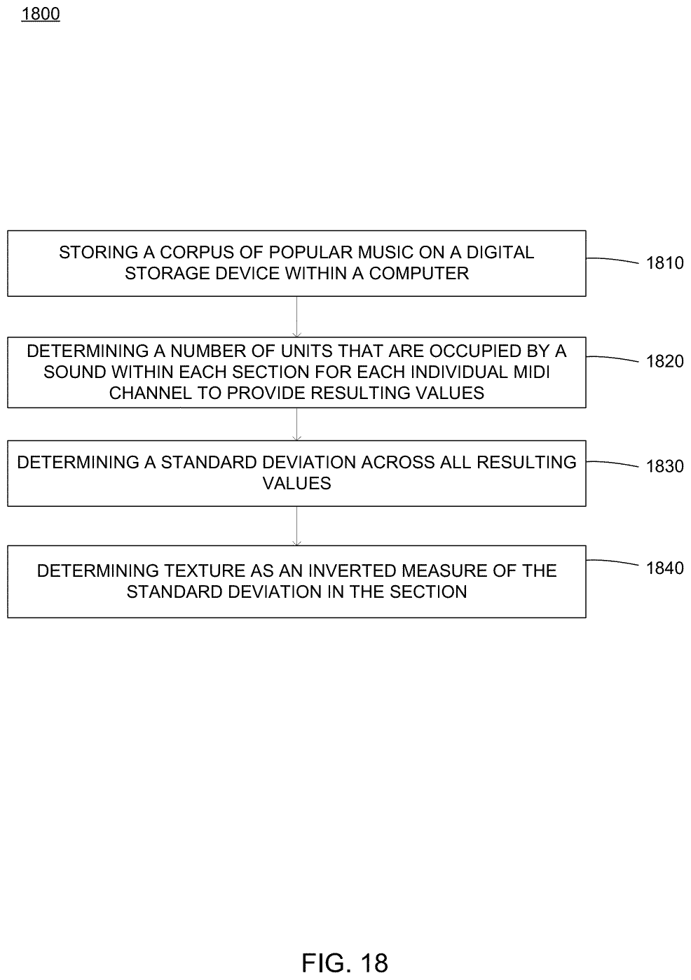

FIG. 18 illustrates a method 1800 for determining texture in a corpus of music (e.g., within the pieces of music therein) according to one or more embodiments. The method 1800 can be executed by a determination engine, as described herein. Generally, texture is a measure of a density of a piece of music. If a piece of music has lots of instruments with different sounds playing in a particular section, then that part of the piece of music has a dense texture. If a piece of music has only one instrument playing in a particular spot, or multiple instruments that all sound basically the same, it has a rarefied texture.

Texture for each window is estimated by taking (by the determination engine) the standard deviation of the Root-Mean-Squared energy values of all the stem files at that same window. This helps measure the similarity or dissimilarity between the stems, and thus is a measure of texture. Equation 30 describes a texture value TX given the Dynamics values D for stem files C taken over a certain window.

$$T X = \sqrt{\frac{{Σ ( {D}_{C} - D )}^{2}}{C}} \qquad Equation 30$$

The method 1800, generally, describes operations by the determination engine for evaluating textural expectation within a corpus of popular music. At block 1810, the determination engine stores a corpus of popular music on a digital storage device within a computer. The corpus includes a plurality of pieces of music, their sections and their corresponding MIDI files. At block 1820, the determination engine determines the number of units that are occupied by a sound within each section for each individual MIDI channel to provide resulting values. At block 1830, the determination engine determines the standard deviation across all resulting values. At block 1840, the determination engine determines texture as an inverted measure of the standard deviation in the section.

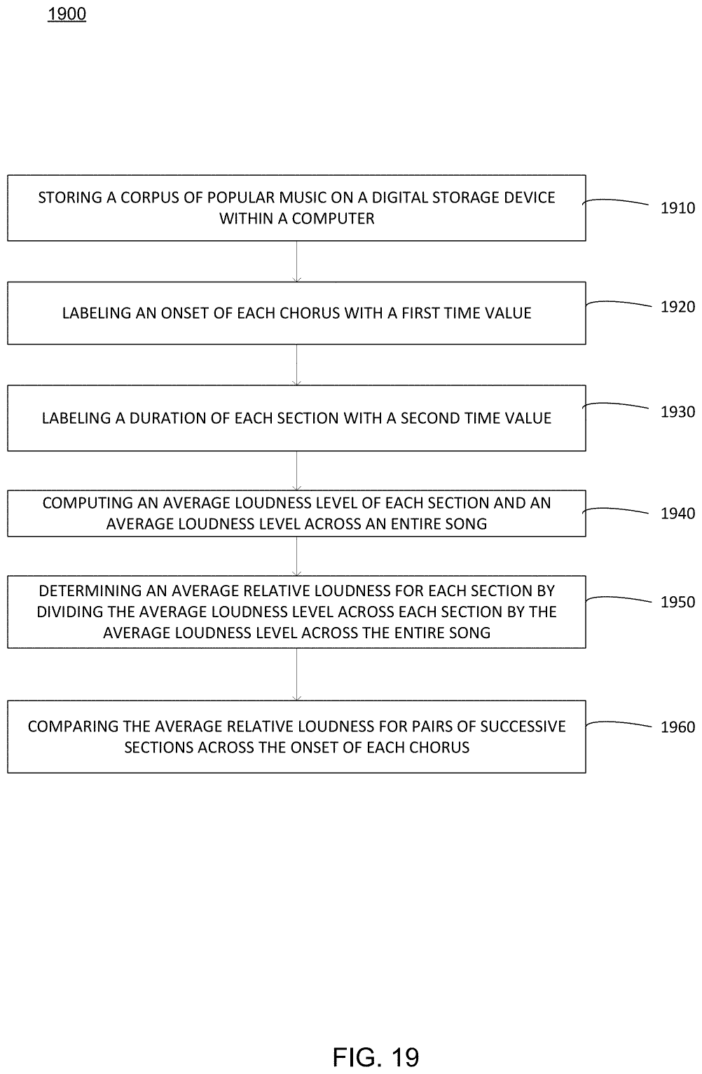

FIG. 19 illustrates a method 1900 for determining dynamics in a corpus of music (e.g., within the pieces of music therein) according to one or more embodiments. To estimate dynamics, the Root-Mean-Squared energy of the audio in each window may be calculated by a determination engine, as described herein. Each value of the signal in that window is squared and then summed (to produce a sum), after which the sum is raised to a power of 0.5. Equation 31 describes determining a dynamics value D in a stem file c, for a windowed waveform x consisting of N samples.

$${D}_{C} = \sqrt{\frac{1}{N} {\sum }_{n = 1}^{N} {\vert {x}_{c} [ n ] \vert}^{2}} \qquad Equation 31$$

Dynamics provides an indication of the amount of energy in the window, which roughly corresponds to the loudness (or dynamics) of the audio. In each window, dynamics is calculated for all five stem files as well as for the mixed audio as a whole.

According to an embodiment, the method 1900 describes operations of the determination engine related to evaluating dynamic expectation within a corpus of popular music. At block 1910 of the method 1900, the determination engine stores a corpus of popular music on a digital storage device within a computer. The corpus includes a plurality of pieces of music, their sections and their corresponding MIDI files. At block 1920, the determination engine labels an onset of each chorus with a first time value. At block 1930, the determination engine labels a duration of each section with a second time value. At block 1940, the determination engine computes an average loudness level of each section and an average loudness level across the entire piece of music. At block 1950, the determination engine determines an average relative loudness for each section by dividing the average loudness level across each section by the average loudness level across the entire piece of music. The first and second time values may be on the order of milliseconds (e.g., may both be in milliseconds). At block 1960, the determination engine computes the average relative loudness for pairs of successive sections across the onset of each chorus. At block 1960, the determination engine can also compute the average relative loudness of each section through MIR. Note that the blocks of the method 19000 can be performed in any order, such as block 1950 may be performed after block 1960.

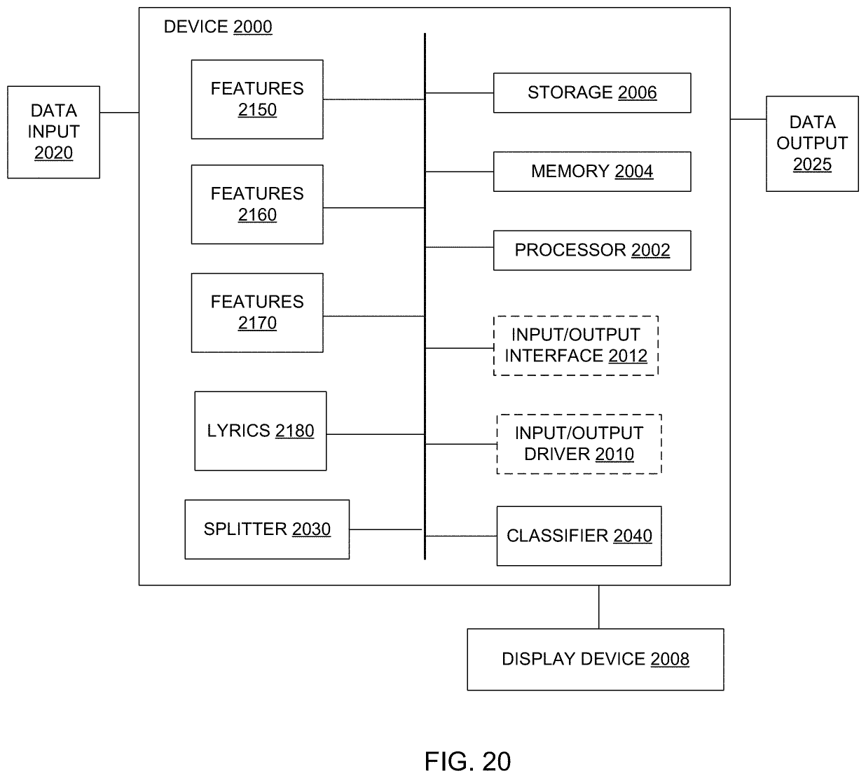

FIG. 20 is a block diagram of an example device 2000 according to one or more embodiments. The example device 2000 can any computing device as described here, with examples there of including, but not limited to, a computer, a gaming device, a handheld device, a set-top box, a television, a mobile phone, and a tablet computer. The example device 2000 includes a processor 112, a memory 114, a storage 2006, one or more input devices, and one or more output devices, such as a display device 2008. The example device 2000 can also optionally include an input/output (I/O) driver 2010 and an I/O interface 2012, as shown by the dashed-boxes. It is understood that the example device 2000 can include additional components. As described herein, the example device 2000 can also include a data input 2020 and a data output 153. The example device 2000 can also include hardware and/or software in the form of a splitter 2030, a classifier 2040, features (e.g., first-order or piece of music level) 2050, features (e.g., second-order or track level) 2060, features (e.g., third-order or preference level) 2070, and lyrics 2080, as has been described herein.

In various alternatives, the processor 112 includes a central processing unit (CPU), a graphics processing unit (GPU), a CPU and GPU located on the same die, or one or more processor cores, wherein each processor core can be a CPU or a GPU. In various alternatives, the memory 114 is located on the same die as the processor 112, or is located separately from the processor 112. The memory 114 includes a volatile or non-volatile memory, for example, random access memory (RAM), dynamic RAM, or a cache.

The storage 2006 includes a fixed or removable storage, for example, a hard disk drive, a solid state drive, an optical disk, or a flash drive. The input devices include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices include, without limitation, a display, a speaker, a printer, a haptic feedback device, one or more lights, an antenna, or a network connection (e.g., a wireless local area network card for transmission and/or reception of wireless IEEE 802 signals).

The I/O driver 2010 communicates with the processor 112 and the input devices, and permits the processor 112 to receive input from the input devices. The I/O driver 2010 communicates with the processor 112 and the output devices, such as the display device 153, and permits the processor 112 to send output to the output devices. It is noted that the I/O driver 2010 is an optional component, and that the device 1900 will operate in the same manner if the I/O driver 2010 is not present. The I/O driver 2010 may include an accelerated processing device (“APD”) which is coupled to the display device 153. The APD accepts compute commands and graphics rendering commands from the processor 112, processes those compute and graphics rendering commands, and provides pixel output to the display device 153 for display. The APD includes one or more parallel processing units to perform computations in accordance with a single-instruction-multiple-data (“SIMD”) paradigm. Thus, although various functionality is described herein as being performed by or in conjunction with the APD, in various alternatives, the functionality described as being performed by the APD is additionally or alternatively performed by other computing devices having similar capabilities that are not driven by a host processor (e.g., the processor 112) and provides graphical output to the display device 153. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

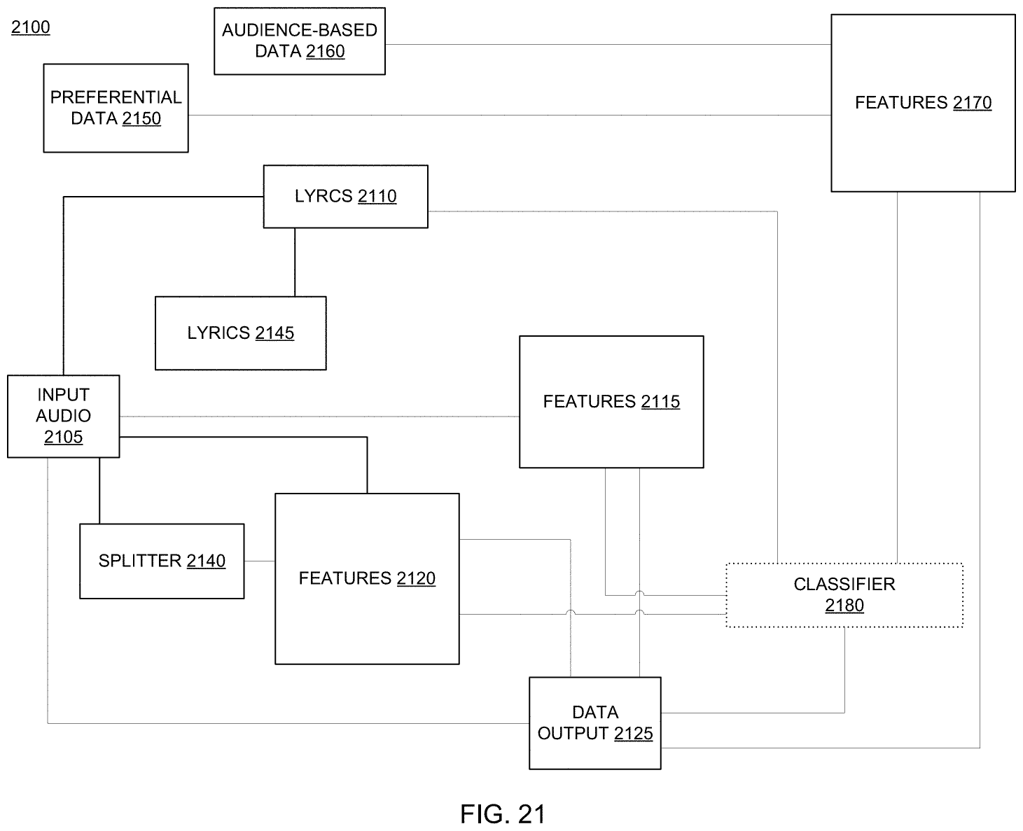

FIG. 21 illustrates a data flow 2100 within the system 400 of FIG. 4 according to one or more embodiments. Data flow 2100 includes the inputs described here. The input audio 2105 is provided to lyrics 2110, features (e.g., first-order or piece of music level) 2115, features (e.g., second-order or track level) 2120, and data output 2125. Additionally, an input audio 2201 is provided to a splitter 2140, which splits the input audio 2201 into split tracks that are provided to the features 2120. In addition to the input audio 2105, the lyrics 2110 also receive an input lyric information 2145. An input preferential data 2150 and an audience-based data 2160 are also provided to features (e.g., third-order or preference level) 2170. The output of lyrics 2110, features 2115, the features 2120, and the features 2170 are all provided to a classifier 2180. In addition to the input audio 2105, the data output 2125 includes the features 2120, the features 2115, the features 2170, and an output of the classifier 2180.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1-20. (canceled)

21. A system comprising:
a memory configured to store processor executable instructions for an analysis unit; and
at least one processor coupled to the memory and configured to execute the processor executable to cause the system to:
receiving a corpus of music data, the corpus of music data including songs comprising notes arranged in chords;
calculating one or more harmonic surprise metrics for each of the songs included in the corpus of music data, the one or more harmonic surprise metrics for each song being indicative of the harmonic surprise of each song;
receiving preference data including information indicative of the popularity of the songs included in the corpus of music data;
identifying a popularity metric for each of the songs in the corpus of music data, the popularity metric for each song being indicative of the popularity of each song;
determining correlations between the harmonic surprise metrics and the popularity metrics for the songs in the corpus of music data;
identifying an individual song;
calculating the one or more harmonic surprise metrics for the individual song; and
estimating the popularity of the individual song based at least in part on the one or more harmonic surprise metrics for the individual song and the correlations between the harmonic surprise metrics and the popularity metrics for the songs in the corpus of music data.

22. The system of claim 21, wherein the correlations are determined by an analysis of variance, a mixed model, a regression analysis, or a machine learning model trained on the data corpus.

23. The system of claim 21, wherein the correlations comprise genre-specific correlations.

24. The system of claim 23, wherein the genre-specific correlations comprise specific correlations to each genre of a song of the data corpus when the song spans across more than one music genre.

25. The system of claim 21, wherein the popularity of the individual song is estimated for a geographic region based on geographic region-specific correlations of the correlations.

26. A computer program product stored on a non-transitory computer readable medium, the computer program product being executable by at least one processor coupled to the non-transitory computer readable medium to the at least one processor to perform:
receiving a corpus of music data, the corpus of music data including songs comprising notes arranged in chords;
calculating one or more harmonic surprise metrics for each of the songs included in the corpus of music data, the one or more harmonic surprise metrics for each song being indicative of the harmonic surprise of each song;
receiving preference data including information indicative of the popularity of the songs included in the corpus of music data;
identifying a popularity metric for each of the songs in the corpus of music data, the popularity metric for each song being indicative of the popularity of each song;
determining correlations between the harmonic surprise metrics and the popularity metrics for the songs in the corpus of music data;
identifying an individual song;
calculating the one or more harmonic surprise metrics for the individual song; and
estimating the popularity of the individual song based at least in part on the one or more harmonic surprise metrics for the individual song and the correlations between the harmonic surprise metrics and the popularity metrics for the songs in the corpus of music data.

27. The computer program product of claim 26, wherein the correlations are determined by an analysis of variance, a mixed model, a regression analysis, or a machine learning model trained on the data corpus.

28. The computer program product of claim 26, wherein the correlations comprise genre-specific correlations.

29. The computer program product of claim 28, wherein the genre-specific correlations comprise specific correlations to each genre of a song of the data corpus when the song spans across more than one music genre.

30. The computer program product of claim 26, wherein the popularity of the individual song is estimated for a geographic region based on geographic region-specific correlations of the correlations.

31. A method comprising:
determining, by an analysis unit executed by one or more processors, one or more harmonic surprise metrics for data corpus;
determining, by the analysis unit, one or more popularity metrics for the data corpus from preference data;
determining, by the analysis unit, correlations between the one or more harmonic surprise metrics and the one or more popularity metrics;
determining, by the analysis unit, one or more specific harmonic surprise metrics for an individual song of unknown popularity; and
estimating, by the analysis unit, a specific popularity of the individual song based on the one or more specific harmonic surprise metrics and the correlations.

32. The method of claim 31, wherein the one or more harmonic surprise metrics indicate an absolute surprise averaging a surprise of finding each distinct chord of a song of the data corpus.

33. The method of claim 31, wherein the one or more harmonic surprise metrics indicate a contrastive surprise differentiating between average surprises of two or more sections of a song of the data corpus.

34. The method of claim 31, wherein the data corpus comprises music data comprising one or more songs, each of the one or more songs comprising notes arranged in chords.

35. The method of claim 31, wherein the preference data comprises at least popularity information for one or more songs of the data corpus.

36. The method of claim 31, wherein the individual song is identified upon downloading from an online digital media store.

37. The method of claim 31, wherein the correlations are determined by an analysis of variance, a mixed model, a regression analysis, or a machine learning model trained on the data corpus.

38. The method of claim 31, wherein the correlations comprise genre-specific correlations or geographic region-specific correlations.

39. The method of claim 38, wherein the genre-specific correlations comprise specific correlations to each genre of a song of the data corpus when the song spans across more than one music genre.

40. The method of claim 28, wherein the specific popularity is estimated for a geographic region based on the geographic region-specific correlations.
